(19) United States
(12) Patent Application Publication
(10) Pub. No.: US 2025/0077995 A1
(43) Pub. Date: Mar. 6, 2025

(54) METHODS AND SYSTEMS OF FACILITATING ASSESSMENT OF A SUITABILITY OF A CANDIDATE FOR A ROLE

(71) Applicant: Catalyzr, Inc., Stonington, ME (US)

(72) Inventor: Trevor Higgs, Atlantic Highlands, NJ (US)

(21) Appl. No.: 18/825,807

(22) Filed: Sep. 5, 2024

Related U.S. Application Data
(60) Provisional application No. 63/580,469, filed on Sep. 5, 2023.

(51) Int. Cl. G06Q 10/0631; G06Q 10/0639; G06Q 10/1053

(52) U.S. Cl. CPC G06Q 10/063112; G06Q 10/06398; G06Q 10/1053

(57) ABSTRACT

The present disclosure provides a method of facilitating assessment of a suitability of a candidate for a role. Further, the method may include receiving a reference cognitive data from an entity device associated with an entity. Further, the reference cognitive data may be associated with a desired candidate associated with the role corresponding to the entity. Further, the method may include receiving a candidate cognitive data associated with the candidate from one or more of a candidate device and the entity device. Further, the candidate cognitive data corresponds to a cognitive skill of the candidate. Further, the method may include analyzing the candidate cognitive data and the reference cognitive data. Further, the method may include determining a cognitive parameter based on the analyzing. Further, the method may include transmitting one or more of the cognitive parameter and a selection data based on the cognitive parameter to the entity device.

### FIELD OF DISCLOSURE

The present disclosure generally relates to the field of data processing. More specifically, the present disclosure relates to methods and systems of facilitating assessment of a suitability of a candidate for a role.

### BACKGROUND

Attracting, engaging, and retaining talent are among the biggest challenges companies face. It is critical for companies to understand their workforce's skills, capabilities, and talents so that they can to plan investments and make decisions on whether to upskill existing employees and hire contractors until the training is completed or to hire new employees to fill in capability gaps. Conversely, employees lack the tools they need to receive career recommendations tailored to their unique set of skills and abilities, they become frustrated and eventually leave the company. These departures cause disruptions to teams, affect organizational productivity and ultimately impact the health of the company itself. Recruiters are then tasked with searching through large pools of candidates to find replacements or fill other open roles; this is often a time-consuming process of reviewing candidate resumes, years of experience, grade point averages, and outside interests-with no little to no quantifiable insight into one candidate's potential to succeed in a position vs another's.

In recent years, this process has been accelerated with the advent of tools based on artificial intelligence that can review these inputs in a fraction of the time and provide recommendations to recruiters, talent managers, or employees looking for career development. However, these systems use the same datasets that recruiters do and come to the same results, only faster.

Research in industrial and organizational psychology has shown significant evidence that General Mental Ability (GMA) is a superior indicator of potential success in employment and on the job learning than methods currently in use such as those listed above. The disclosed system may use cognitive assessments and skills self-assessments to collect information about a person's cognitive abilities and skills. The system can evaluate a current employee's performance on the cognitive assessments and create a unique cognitive profile for the employee. Companies may identify top performing employees for the system to use to create an “exemplar” model that describes the company's unique profile of success at that position. A system of the present disclosed system can be used by companies to identify talent that has a high potential for success for a specific position based on an analysis of an individual's unique cognitive profile and the cognitive profile created for the specific position(s). The system may use predictive models based on cognitive assessments to provide companies with a quantified understanding of their workforce's skills, capabilities, and talents and provide insights into their potential to succeed. Accurate predictive models may answer questions about an employee's future performance to guide employers to optimize their talent processes such as workforce planning, learning, career development, and recruitment sourcing.

A quantitative platform that: measures a workforce's skills, capabilities, and talents to create a unique profile of success for each role in the company; quantifies the potential to succeed for a person in the workforce for any role in the company; and provides users training guidance to prepare for that role, remains unavailable.

The present disclosed system aims to solve this problem by disclosing a system and method for making talent recommendations using a metric to quantify a person's potential to succeed in one or more roles within a company. This is done using a predictive model that analyzes a person's cognitive traits against a role profile consisting of the combined cognitive traits of workers considered to be exemplars of the role. The present disclosed system may further provide skill development recommendations based on the person's self-identified skills and capabilities.

### SUMMARY OF DISCLOSURE

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

The present disclosure provides a method of facilitating assessment of a suitability. Further, the method may include receiving, using a communication device, a reference cognitive data from an entity device associated with an entity. Further, the reference cognitive data may be associated with a desired candidate associated with a role corresponding to the entity. Further, the method may include receiving, using the communication device, a candidate cognitive data associated with the candidate from one or more of a candidate device and the entity device. Further, the candidate cognitive data corresponds to a cognitive skill of the candidate. Further, the method may include analyzing, using a processing device, the candidate cognitive data and the reference cognitive data. Further, the method may include determining, using the processing device, a cognitive parameter based on the analyzing. Further, the method may include transmitting, using the communication device, one or more of the cognitive parameter and a selection data based on the cognitive parameter to the entity device.

The present disclosure provides a system for facilitating assessment of a suitability. Further, the system may include a communication device. Further, the communication device may be configured to receive a reference cognitive data from an entity device associated with an entity. Further, the reference cognitive data may be associated with a desired candidate associated with a role corresponding to the entity. Further, the communication device may be configured to receive a candidate cognitive data associated with the candidate from one or more of a candidate device and the entity device. Further, the candidate cognitive data corresponds to a cognitive skill of the candidate. Further, the communication device may be configured to transmit one or more of a cognitive parameter and a selection data associated with the cognitive parameter to the entity device. Further, the system may include a processing device communicatively coupled with the communication device. Further, the processing device may be configured to analyze the candidate cognitive data and the reference cognitive data. Further, the processing device may be configured to determine a cognitive parameter based on the analyzing.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to the respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a block diagram of a system 100 comprising a talent optimization system 104, in accordance with some embodiments.

FIG. 2 is a block diagram illustrating the different modules inside the talent optimization system 104, in accordance with some embodiments.

FIG. 3 is an illustration of the class diagram of the talent optimization system 104, in accordance with some embodiments.

FIG. 4 is an illustration of elements of General Mental Ability that may be assessed in the talent optimization system 104, in accordance with some embodiments.

FIG. 5 is a flowchart of an exemplary method for creating an exemplar profile within the talent optimization system 104, in accordance with some embodiments.

FIG. 6 is a flow diagram of an exemplary first method showing a method of use for the talent optimization system 104, in accordance with some embodiments.

FIG. 7 is a flow diagram of an exemplary second method showing a method of use for the talent optimization system 104, in accordance with some embodiments.

FIG. 8 is a flow diagram of an exemplary third method showing a method of usage for the talent optimization system 104, in accordance with some embodiments.

FIG. 9 is a block diagram showing an exemplary embodiment of the system 900 of the application, in accordance with some embodiments.

FIG. 10 is an illustration of an online platform 1000 consistent with various embodiments of the present disclosure, in accordance with some embodiments.

FIG. 11 is a block diagram of a computing device 1100 for implementing the methods disclosed herein, in accordance with some embodiments.

FIG. 12 illustrates a flowchart of a method 1200 of facilitating assessment of a suitability, in accordance with some embodiments.

FIG. 13 illustrates a flowchart of a method 1300 of facilitating assessment of a suitability including generating, using the processing device 1504, a recommendation plan associated with development of the cognitive skills of the candidate, in accordance with some embodiments.

FIG. 14 illustrates a flowchart of a method 1400 of facilitating assessment of a suitability including generating, using the processing device 1504, a recommended role data associated with the entity, in accordance with some embodiments.

FIG. 15 illustrates a block diagram of a system 1500 of facilitating assessment of a suitability, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performances of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

There is a need for systems and methods that can be used by companies and different entities to quantify an individual's potential to succeed in a role and present it as an easy-to-understand metric called the “Catalyzr Quotient” that can be used to: (1) identify “high-potential” talent for a specific job role, and (2) identify high-potential employees and recommend placement of those employees in positions that optimize their potential.

The present disclosure provides a method of facilitating the quantification of an individual's potential to succeed in a role through the use of assessments of general mental ability and machine learning algorithms to be used by the individual or entity for talent management processes including, but not limited to, career development, workforce planning, and recruiting (targeting internal and external candidates).

The systems and methods disclosed herein can address at least the above needs. In some embodiments, the systems and methods can match candidates with companies based on the candidates' quantified potential for success presented metric called the “Catalyzr Quotient” derived from the output of one or more cognitive science-based assessments of general mental ability and machine learning algorithms. The candidates' output may be compared against an employee model that is representative of an ideal employee for a specific position in the company. The plurality of cognitive assessments is designed to test/measure a wide array of cognitive traits, including, but not limited to, critical thinking, abstract reasoning, and problem-solving. Using these cognitive assessments, and the analysis of results against the employee model, can help a company optimize its recruiting and candidate sourcing process. In addition to being a helpful recruiting tool for companies, the systems and methods disclosed herein can assist individuals in career planning, and support Human Resources in talent identification and company-wide workforce planning. By using assessments that measure cognitive traits and comparing them to either a standardized role or an idealized employee model for the role, the system and methods can quantify the test subject's potential to succeed in that role and any other role in the company to recommend which roles are suitable for the test subject.

In some embodiments, the plurality of participants may be employed by the entity. The select group of participants may correspond to a group of employees of the entity who at least meet a set of job-performance metrics that are predefined by the entity. The statistical model may be correlated with the set of job-performance metrics.

According to one aspect, a system for implementing a cognitive assessment-based method of quantifying potential based on an idealized employee model (or Exemplar model) is provided. The system may comprise a server in communication with a plurality of computing devices associated with multiple individuals identified by the company or entity to be used in the idealized employee model for a specific role (designated as ‘participants’ going forward). In some embodiments, the plurality of participants may be employed by the entity. The select group of participants may correspond to a group of employees of the entity who at least meet a set of job-performance metrics that are predefined by the entity. The statistical model may be correlated with the set of job-performance metrics.

The server may comprise a memory for storing interactive media and a first set of software instructions, and one or more processors configured to execute the first set of software instructions to provide interactive media to multiple computing devices associated with multiple concurrent participants. The interactive media may comprise at least one cognitive assessment that is designed to measure one or more cognitive traits of the participants. The assessment may include a plurality of predefined sets of graphical visual objects associated with a plurality of selected cognitive science-based computerized tasks. The plurality of predefined sets of visual objects may be displayed to the participants on graphical displays of the computing devices.

One or more processors may also be configured to execute the first set of software instructions to receive input data from the computing devices as the participants complete their cognitive assessments on the graphical displays of the computing devices by manipulating or selecting one or more of the graphical visual objects on the graphical displays using one or more input devices to complete multiple selected cognitive science-based computerized tasks.

One or more processors may be further configured to execute the first set of software instructions to analyze the input data derived from the participants' manipulation of one or more graphical visual objects within the assessment to (1) extract measurements of the participants' cognitive traits based on the selection of manipulation of the graphical visual object(s) by the participants, (2) generate a statistical model based on the measurements of the participants' cognitive traits, wherein the statistical model is representative of a select group of participants. and (3) quantify the potential for success of each participant in that specific role by comparing the measurements of the participants' cognitive traits to the statistical model, presenting it as a metric called the “Catalyzr Quotient.”

While the systems and methods disclosed herein can assist individuals in career planning and support Human Resources in talent identification and company-wide workforce planning, they are primarily a recruiting solution for companies. While employees and candidates may use the solution for expediency and clarity, the term “candidate” will include employees seeking career planning and candidates seeking a job.

According to one aspect, a system for implementing a cognitive assessment-based method of quantifying potential based on an idealized employee model (or Exemplar model) is provided. The system may comprise a server in communication with a plurality of computing devices associated with multiple candidates who have applied to a role. The server may comprise a memory for storing interactive media and a first set of software instructions, and one or more processors configured to execute the first set of software instructions to provide interactive media to multiple computing devices associated with multiple concurrent candidates. The interactive media may comprise at least one cognitive assessment that is designed to measure one or more cognitive traits of the candidate. The assessment may include a plurality of predefined sets of graphical visual objects associated with a plurality of selected cognitive science-based computerized tasks. The plurality of predefined sets of visual objects may be displayed to the participants on graphical displays of the computing devices.

One or more processors may also be configured to execute the first set of software instructions to receive input data from the computing device as the candidate completes their cognitive assessments on the graphical displays of the computing devices by manipulating or selecting one or more of the graphical visual objects on the graphical displays using one or more input devices to complete multiple selected cognitive science-based computerized tasks.

In some embodiments, one or more processors may be configured to measure the candidate's assessment performance by comparing measurements of the candidate's cognitive traits to the statistical model for a specific role, presenting it as a metric called the “Catalyzr Quotient.”

In some embodiments, one or more processors may be configured to calculate and quantify the candidate's potential for success by comparing the measurements of the candidate's cognitive traits to the statistical model, presenting the result as a metric called the “Catalyzr Quotient.” The Catalyzr Quotient metric quantifies the candidate's level of match with a select group of participants, thus representing the candidate's potential to succeed in that role. One or more processors may also be configured to display a comparison of the Candidate's Catalyzr Quotient against the participants who comprised the Exemplar Model in a graphical display of at least one computing device. This comparison may be used to determine a candidate's suitability for recruitment into a target position based on the candidate's potential to succeed in the role as quantified by the Catalyzr Quotient.

In some embodiments, one or more processors may be configured to generate a plurality of fit scores for a plurality of candidates based on comparisons of measurements of the candidates' cognitive traits to the statistical model. The fit scores may be indicative of a level of match of the candidates with the select group of participants. One or more processors may also be configured to effect display a plurality of candidates indicative of the plurality of Catalyzr Quotient scores on the graphical display. One or more processors may also be configured to display a comparison of the candidate's Catalyzr Quotient against multiple other candidates, such as a graphical display of at least one computing device. This comparison may be used to determine a candidate's suitability for recruitment into a target position based on the candidate's potential to succeed in the role as quantified by the Catalyzr Quotient against other candidates' potential to succeed.

In some embodiments, a computer program product comprising a computer-readable medium with computer-executable code encoded therein is provided. The computer-executable code may be adapted to be executed to implement a method comprising: a) a recruitment system, wherein the recruitment system comprises i) an assessment module, ii) a calculation module, and iii) a recommendation module; b) providing by the assessment module a plurality of computerized tasks designed to measure a subject's general mental abilities; c) quantifying a subject's potential to succeed in a role based on a statistical model of success for the role, and d) identifying if a subject is suitable for hiring by an entity based on their quantified potential to recruiter or hiring manager.

In some embodiments, a computer program product comprising a computer-readable medium with computer-executable code encoded therein is provided. The computer-executable code may be adapted to be executed to implement a method comprising: a) a talent identification system, wherein the talent identification system comprises: i) an assessment module, ii) a calculation module, and iii) a recommendation module; b) providing by the assessment module a plurality of computerized tasks designed to measure a subject's general mental abilities; c) quantifying a subject's a career propensity based on their potential to succeed based on a statistical model of success for the role; d) identifying a subject's identified career propensity to the subject and a learning and development officer.

The present disclosure describes a system and a method for 1) making talent recommendations using a metric that quantifies a person's potential to succeed in one or more roles within a company, based on a predictive model that analyzes a person's cognitive traits against a role profile consisting of the combined cognitive traits of workers considered to be exemplars of the role, and 2) providing skill development recommendations based on the person's self-identified skills and capabilities.

In some embodiments, the disclosed system provides a computer program product comprising a computer-readable medium having computer-executable code encoded therein, the computer-executable code adapted to be executed to implement a method comprising of a talent identification system that is made up of an assessment module, a calculation module, and a recommendation module. The assessment module provides cognitive assessments to a user and captures the results in a unique cognitive profile. The calculation module assesses the traits captured in the cognitive profile against a standardized role profile and/or an exemplar role profile unique to the company. The recommendation module suggests roles identified as “high potential for success” to an assessment taker and/or a person representing the Human Resources in support of workforce planning, learning, career development, and recruitment sourcing activities.

All illustrations of the drawings are for the purpose of describing selected versions of the present disclosed system and are not intended to limit the scope of the present disclosed system.

The words “a”, “an”, or “the” as used in the context of this document should be understood to refer to both single and plural of the component in question—for example, reference to “a system” should be understood to include reference to “a plurality of systems” or “at least one system”.

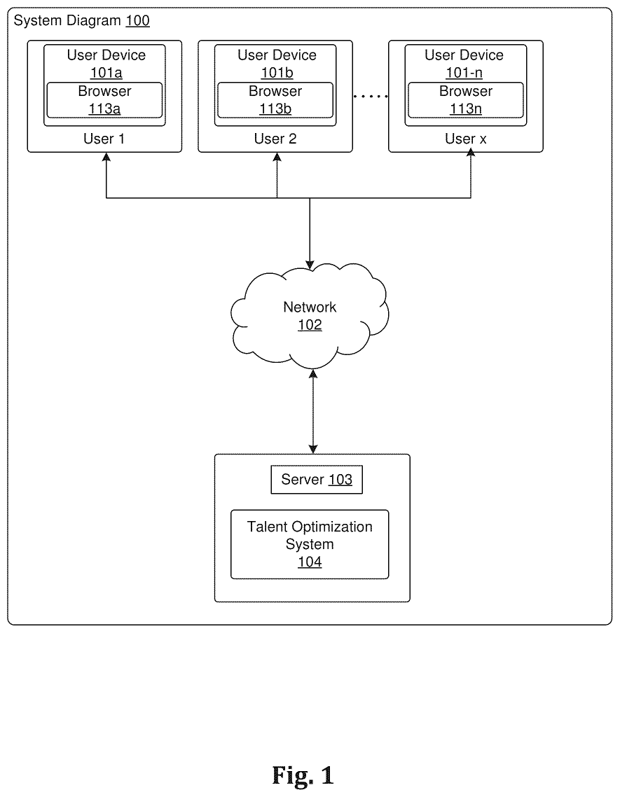

FIG. 1 is a block diagram of a system 100 comprising a talent optimization system 104, in accordance with some embodiments. Further, an architecture of the system 100 may be adapted to support one embodiment of the present disclosed system. FIG. 1 and the other figures use reference letters to identify like elements. A letter after a reference numeral, such as “101a,” indicates that the text refers specifically to the element having that reference numeral. A reference numeral in the text without a following letter, such as “101,” refers to any or all of the elements in the figures bearing that reference numeral (e.g., “101” in the text refers to reference numerals “101a” and/or “101b” in the figures). The use of “-n” in the notation denotes a variable number of the element where “n”>2 (e.g., “101-n” in the text refers to the number of elements where “n”>2).

One or more users may be comprised of current company employees, candidates (internal and external) as well as former employees, etc. who may use the system's cognitive assessments to receive data-driven career development recommendations based on the potential to be successful at different positions within the company, as well as to understand what skills they need to develop for the position.

In some embodiments, the software or applications may include a web-based portal configured to receive and analyze information collected from the cognitive assessments and to report results to one or more end users working for the company. The end users may include recruiters, human resource personnel, company managers, supervisors, etc.

User Device 101: A user device may be, for example, one or more computing devices configured to perform one or more operations consistent with the disclosed embodiments. For example, a user device may be a computing device that may execute software or applications provided by the talent optimization system 104. In some embodiments, the software may provide cognitive assessments designed to collect information about a person's cognitive general mental abilities to create a cognitive profile. In some embodiments, the software may provide skills associated with a person's current or potential position to collect information about a person's level of competency in those skills. In some embodiments, the software may suggest skills associated with a person's current or potential position to provide training recommendations to the person and then collect information on the person's level of competency in those skills after the training is complete. A company may use the information to optimize its workforce planning, learning, development, recruiting, and candidate-sourcing processes. The cognitive assessments may be hosted by the server, accessed by one or more interactive web pages, and taken by one or more users.

The User devices 101 are used by employees/candidates and HR/managers to interact with the talent optimization system 104. A user device maybe any device that is or incorporates a computer such as a personal computer (PC), a desktop computer, a laptop computer, a notebook, a smartphone, or the like. A computer is a device that has one or more general or special purpose processors, memory, storage, and networking components (either wired or wireless). The device executes an operating system, for example, a Microsoft Windows-compatible operating system (OS), Apple OS X or iOS, a Linux distribution, or Google's Android OS. In some embodiments, the user device 101 may use a web browser 113, such as Microsoft Internet Explorer, Mozilla Firefox, Google Chrome, Apple Safari, and/or Opera, as an interface to interact with the talent optimization system 104.

In the embodiment of FIG. 1, two-way data transfer capability is provided between the server and each user device enabling assessment results to be gathered from the user and recommendations be made to the user.

Network 102: The Network 102 represents the communication pathways between a user 101 and the talent optimization system 104. In one embodiment, the network is the Internet. The network may also utilize dedicated or private communication links (e.g. WAN, MAN, or LAN) that are not necessarily part of the Internet. The network uses standard communications technologies and/or protocols.

Server 103: A server may comprise one or more server computers configured to perform operations consistent with disclosed embodiments. In one aspect, a server may be implemented as a single computer, through which a user device is able to communicate with other components of the network layout. In some embodiments, a user device may communicate with the server through the network. In other embodiments, the server may communicate on behalf of a user device with the talent optimization system 104 or the database through the network. In some embodiments, the server may embody the functionality of one or more system(s).

The server may, in some embodiments, utilize the talent optimization system 104 to process input data from a user device to determine the user's performance on cognitive assessments and to analyze the user's assessment scores to determine a match between the user and a set of role or exemplar profiles. The server may be configured to store the user's assessment data in the database. The server may also be configured to search, retrieve, and analyze data and information stored in the database.

In some embodiments, a server may include a web server, an enterprise server, or any other type of computer server, and it may be computer programmed to accept requests (e.g., HTTP, or other protocols that may initiate data transmission) from a computing device (e.g., a user device) and to serve the computing device with requested data. A server may also be a server in a data network (e.g., a cloud computing network). While FIG. 1 illustrates the server as a single server, in some embodiments, multiple devices may implement the functionality associated with the server.

Talent Optimization System 104: The talent optimization system 104 may be implemented as one or more computers storing instructions that, when executed by one or more processor(s), process the results of a user's cognitive assessment score(s) and performs a machine learning algorithm to determine the correlation between the user's cognitive profile and a standard occupation profile and to determine the user's potential to succeed at that position.

The talent optimization system 104 may further be implemented as one or more computers storing instructions that, when executed by one or more processor(s), performs a machine learning algorithm for processing cognitive assessment data from multiple employees selected by the company to generate an idealized employee model that represents an exemplar profile for a specific position within a company (this will be referred to going forward as the “exemplar model” or “exemplar profile”).

The talent optimization system 104 may further store and/or execute software that performs a machine learning algorithm to determine a correlation between the user's cognitive profile and a standard occupation profile and/or the exemplar profile and expresses the user's potential to succeed at that position as a numeric value between 0-100 and is called the “catalyzr quotient”. The higher the catalyzr quotient, the greater the potential of the user succeeding in the position.

The talent optimization system 104 may, based on the user's interest in a position, suggest skills the user may have and capture the user's skill self-assessment score(s). Based on the user's self-assessment, the system may suggest skills that the user may wish to train in to prepare for the position. The talent optimization system 104 may further store and/or execute software that performs a machine learning algorithm to suggest “related” skills to users based on the user's claimed skills, “related” skills being drawn from a similar skill category/skill sub-category within the skill ontology store, or be a skill possessed by other users who have a similar position. The talent optimization system 104 may further store and/or execute software that performs a machine learning algorithm to search, retrieve, and analyze cognitive data, skills data, and job performance data of employees/candidates that is stored in the database for the purpose of making recommendations to the company about organizational skill development needs and gaps, resource preparedness for a position, as well as suggestions about where to proactively move resources to optimize the potential for success.

The disclosed embodiments may be configured to implement the talent optimization system 104 such that a variety of machine learning algorithms may be used to perform one or more of the data-driven talent identification techniques listed above.

Those skilled in the art will appreciate that the talent optimization system 104 may contain other modules not described herein. In addition, conventional elements, such as firewalls, authentication systems, payment processing systems, network management tools, load balancers, and so forth, are not shown as they are not material to the disclosed system. The talent optimization system 104 may be implemented using a single computer or a network of computers, including cloud-based computer implementations. The computers are preferably server-class computers that include one or more high-performance CPUs and 1G or more of main memory, and they run an operating system such as LINUX or variants thereof. The operations of the system as described herein may be controlled through either hardware or computer programs installed in non-transitory computer storage and executed by the processors to perform the functions described herein.

The various stores (e.g., Client Data Store, Exemplar Store, etc.) are implemented using non-transitory computer-readable storage devices and suitable database management systems for data access and retrieval. The system includes other hardware elements necessary for the operations described here, including network interfaces and protocols, input devices for data entry, and output devices for display, printing, or other data presentations.

Although computing devices are illustrated and networks described, it is to be appreciated and understood that other computing devices and networks may be utilized without departing from the spirit and scope of the embodiments described herein. In addition, one or more components of the network layout may be interconnected in a variety of ways and may, in some embodiments, be directly connected to, co-located with, or remote from one another, as one of ordinary skill will appreciate.

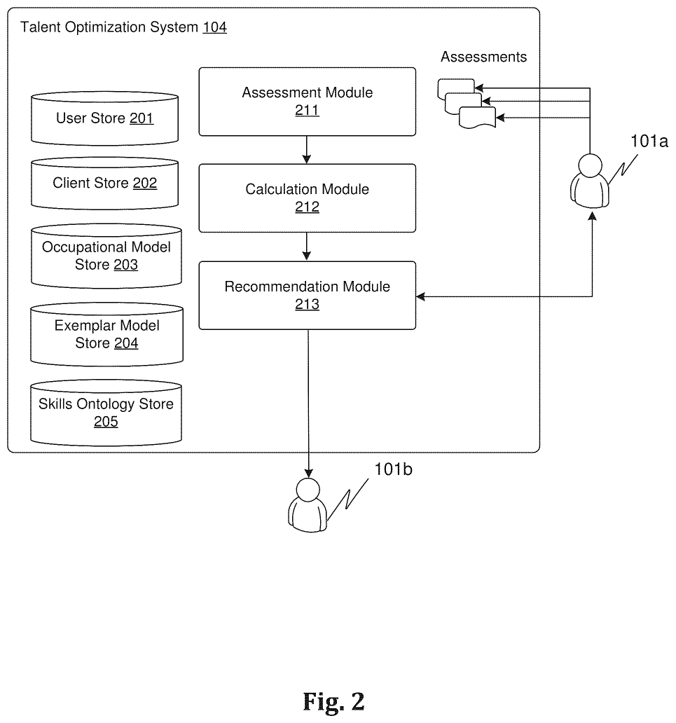

FIG. 2 is a block diagram illustrating the different modules inside the talent optimization system 104, in accordance with some embodiments. As previously described, the screening system may be implemented inside and/or outside of a server. For example, the screening system may be software and/or hardware components included with the server, or remote from the server.

Accordingly, the talent optimization system 104 comprises a User Store 201, a Client Store 202, an Occupational Model Store 203, an Exemplar Model Store 204, a Skills Ontology Store 205, an Assessment Module 211, a Calculation Module 212, and a Recommendation Module 213. As described above, in the ideal embodiment, it should be understood the components described in the paragraph may be located on the server 103, or these components may be implemented as separate databases and configured to communicate over the network 102 with all other components, as is well known in the art. In some embodiments, it is contemplated that one or more of these components may be stored locally on a user device or other local computing device.

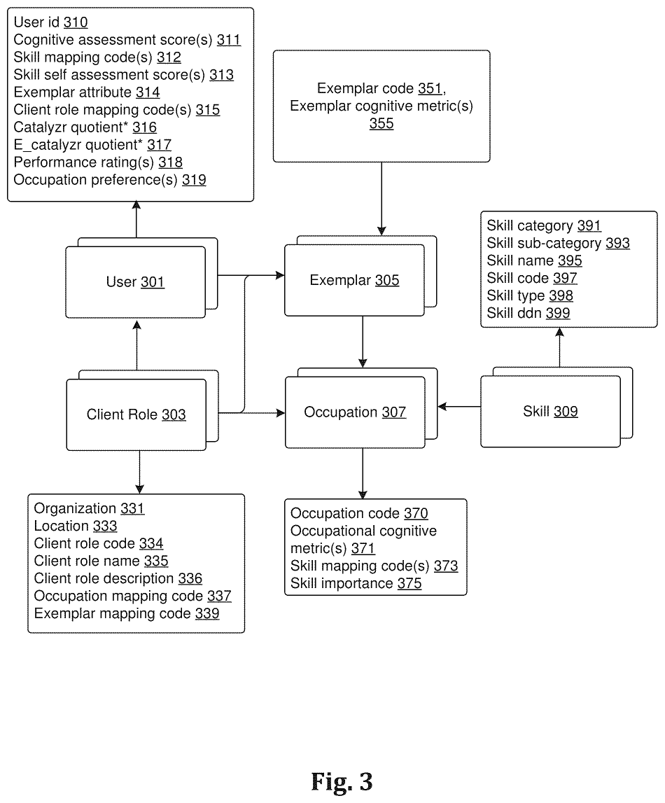

FIG. 3 is an illustration of the class diagram of the talent optimization system 104, in accordance with some embodiments.

Accordingly, in FIG. 3, each user 101 is represented by the user object 301, which may also be called the user profile. Users 101 may be both user(s) 101a and user(s) 101b and are kept in a single user store that has a single user profile 301 that stores assessment related information as well as reporting user information. The scheme eliminates the need for managing two separate user stores and reduces the amount of redundant information held in the system. The single user profile 301 will include such information as a unique ID, name, user name, email address, location, employee ID (if user is an employee of the company), work location (if user is an employee of company), work unit (if user is an employee of company), current job (if user is an employee of company), current & past performance ratings (if user is a current employee), mobile phone number, system role etc. Moreover, the user store 201 may store additional information such as user id 310, cognitive assessment score(s) 311, skill mapping code(s) 312, skill self-assessment score(s) 313, exemplar attribute 314, client role mapping code(s) 315, catalyzr quotient 316, e_catalyzr quotient 317, performance rating(s) 318, occupation preference(s) 319.

Each user profile 301 is mapped by the client role mapping code(s) 315 to the client role code 334 which is found in the client role profile 303. The relationship establishes the user(s) 101a current position. Each user profile 301 may have only one client role mapping code(s) 315 (i.e., each user may only have one current job within a company). Each user profile 301 may have n number of skill mapping code(s) 312 which are mapped to a skill code 397 that represents a skill 309, held in the skill ontology store 205. In the way any number of skills may relate to a user profile 301 and the user 101 may self-assess the capabilities for the skill mapping code(s) 312 in the skill self-assessment score(s) 313. Each user profile 301 may have n number of catalyzr quotients 316, based on the number of positions that are available for assessment in client store 202 that have been mapped to occupation profiles 307. Further, each user profile 301 may be associated with a landing page, the landing page being adapted to display any relevant information to the user 101a. The information displayed on the landing page may include messages, ratings, quotients, or any other information deemed relevant for display by a user 101b, such as a system administrator.

In some embodiments, the exemplar attribute may be assigned to a user(s) 101a who is an employee of a company by a user(s) 101b. The exemplar attribute 314 indicates that the user(s) 101a is considered an ideal employee for the current role and that the company wishes to use the user(s) 101a cognitive assessment score(s) 311 as part of an exemplar profile 305 exemplar cognitive metric(s) 355. The details of the calculation of the exemplar cognitive metric(s) 355 may be described later in the document.

The catalyzr quotient 316 is a numeric value that represents the correlation between the user's cognitive assessment score(s) 311 and the standard occupation profile 307 The e_catalyzr quotient 317 is a numeric value that represents the correlation between the user's cognitive assessment score(s) 311 and the exemplar profile 305 and expresses the user's potential to succeed at that position. The higher the catalyzr quotient 316 and/or e_catalyzr quotient 317 are, the greater the likelihood of the user succeeding in the position. The details of the calculation of the catalyzr quotient 316 and the e_catalyzr quotient 317 may be described later in the document.

FIG. 2 and FIG. 3 Talent optimization system 104 and Class Diagram

Accordingly, FIG. 2 further illustrates the user store 201 persistently stores data describing end user(s) 101 that may access the talent optimization system 104. End users fall into two categories and are shown in FIG. 2 as user(s) 101a and reporting user(s) 101b. For brevity, they may be denoted going forward as “user(s) 101a” and “user(s) 101b”.

User(s) 101a may be current employees, candidates (internal or external), or former employees of the company. The group of employees may comprise some or all the employees of the company. In some embodiments, the group of employees may comprise a select group of employees in the company. A group of employees may be selected based on geographical location, job functions, job performance, or any other factors. Job candidates may include users who are applying for a specific position in the company, active jobseekers, recent college graduates, students, etc. User(s) 101b may be an employee or employees of the company who is part of the human resources organization (e.g., talent development analyst, a recruiter, workforce planning analysts, etc.) or a manager(s), in some embodiments, the user(s) 101b may be assigned system permissions to manage, modify, or otherwise alter values associated with the system or user object 301. In some embodiments, user(s) 101b may be employees of a third party that may or may not be affiliated with the company.

Client Store 202: The client store 202 persistently stores data describing the client's organizational data. FIG. 3 shows, each role is represented by the client role object 303, which may also be called the client role profile. The client role profile 303 may include such information as client role code 334, client role name 335, client role description 336, occupation mapping code 337, and exemplar mapping code 339. A client role profile 303 may be mapped to one or more user profiles 301. While the client role profile 303 contains company specific information, the client role profile 303 does not have the cognitive data required for the calculation module 212 to calculate the catalyzr quotient for a user(s) 101a. As such, the talent optimization system 104 must be configured so that a client role profile 303 is mapped to an object that may provide the cognitive data. In the talent optimization system 104, there are two objects that hold cognitive data: the occupation profile 307 and the exemplar profile 305. The mapping of the client role profile 303 to each of these objects may be discussed later in the document.

Occupational Model Store 203: The Occupational Model Store 203 holds a standardized set of over 2,000 occupations for use in the talent optimization system 104. FIG. 3 shows each occupation is represented by an occupation object 307, which may also be called an occupation profile. The occupation profile 307 may include such information as an occupation such as occupation category, occupation name, occupation description, knowledge areas, skills, and abilities. Moreover, the occupational model store 203 may store additional information such as the occupation's occupation code 370, cognitive metric(s) 371, and skill mapping code 372, skill level 373, and skill importance 375. In one embodiment, one occupation profile 307 may be mapped to one or more client role profiles 303 in the client store 202 because the client role profiles 303 are similar in nature and share attributes between themselves. In another embodiment, an occupation profile 307 may be mapped on a one-to-one basis with client role profile 303 in the client store 202. An occupation profile 307 may be configured to map to one or more skill profiles 309 in the skill ontology store 205. Each occupation profile 307 may have n number of skill mapping code(s) 312 which are mapped to a skill code 397 that represents a skill 309, held in the skill ontology store 205. In the way, any number of skills may relate to an occupation profile 307.

Exemplar Model Store 204: The exemplar store 204 persistently stores data describing how a user(s) 101a cognitive assessment score(s) 311 may be used in isolation or possibly combined with other user(s) 101a cognitive assessment score(s) 311 to create a company specific exemplar profile 305 which represents an ideal employee profile against which other user profiles 301 may be compared to as part of the calculation of potential known as the catalyzr quotient 316. Each exemplar is represented by an exemplar object 305, which may also be called an exemplar profile. The exemplar profile 305 may include exemplar code 351, as well as consolidated exemplar cognitive metric(s) 355. The exemplar profile 305 represents an ideal employee profile, the exemplar code 351 is used to track the data and information related to that ideal profile in the same way that the user id 310 is used to identify and track users 101.

Skills Ontology Store 205: The skill store 205 persistently stores data describing skill(s) available to the talent optimization system 104 in the skill ontology. Each skill is represented by a skill object 309, which may also be called a skill profile. Information about skill(s) includes skill category 391, skill sub-category 393, skill name 395, skill code 397, skill type 398 (e.g., hard, or soft skill), skill ddn 399 (e.g., if a skill is Defining, Distinguishing, & Necessary).

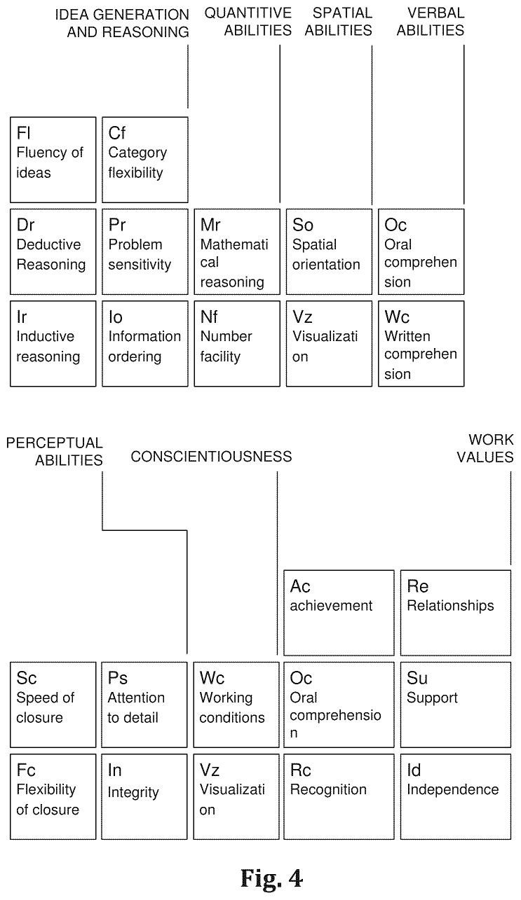

Assessment Module 211: As shown in FIG. 2, the assessment module 211 may be configured to provide cognitive assessments (both showing questions and receiving answers) to a plurality of user(s) 101a. The cognitive assessments may be administered to the user(s) 101a by the company. Cognitive assessments measure elements of General Mental Ability illustrated in FIG. 4 and may include assessments of arithmetic reasoning, verbal aptitude, spatial aptitude, perceptual speed, critical thinking, and problem-solving.

In some embodiments, the cognitive assessments may be provided by the talent optimization system 104 using one or more interactive webpages or through mobile applications. The assessment module 211 may receive data (e.g., answers to the questions in the cognitive assessments) input by the user(s) 101a, and calculate a score for each cognitive assessment, saving the results to the cognitive assessment score(s) 311, in the user profile 301 of the user(s) 101a housed in the user store 201. The user(s) 101a cognitive assessment score(s) 311 are unique to the individual and are saved to the user profile 301 and retained in the user store 201 for use at a later point by the calculation module 212.

Calculation Module 212: The system uses machine learning algorithms to perform regression analysis on the results of the user(s) 101a cognitive assessment and the systems standard cognitive model as well as the exemplar model for a role to create a metric representing the user(s) 101a potential success for a specific within the company, the measure is called the catalyzr quotient 316/e_catalyzr quotient 317. The catalyzr quotient 316 is the aggregation of cognitive assessment score(s) 311 from the individual assessments correlated to the cognitive data associated with the position that the client role profile 303 inherits from either the operational model store 203. If the client role profile 303 also has an exemplar mapping code 339 associated with it, then the system may also calculate an e_catalyzr quotient 317 in addition to the catalyzr quotient 316. The e_catalyzr quotient 317 is the aggregation of cognitive assessment score(s) 311 from the individual assessments correlated to the cognitive data associated with the position that the exemplar role profile 305 inherits from the exemplar model store 205.

The catalyzr quotient 316 may be in range from 0-100 and predicts the likelihood of a user(s) 101a potential success for a specific position within the company based on a standard profile provided by the system. While a catalyzr quotient 316 may be in a range from 0-100, only scores that are above 70 are considered strong matches and high potential.

The e_catalyzr quotient 317 may be in a range from 0-100 and predicts the likelihood of a user(s) 101a potential success for a specific position within the company based on the exemplar profile which is a synthetic profile made up of the exemplar cognitive metric(s) 355 which model the cognitive abilities of the top performers for that position as identified by the company. The scores of the e_catalyzr quotient 317 also may be in range from 0-100, only scores that are above 70 are considered strong matches and high potential.

However, the FIG. 3 class diagram shows that while the client role profile 303 contains company specific information, the client role profile 303 does not have the cognitive data required for the calculation module 212 to calculate an assessment taker's 101a catalyzr quotient 316 for the position described in the client role profile 303. As such, the talent optimization system 104 must be configured so that a client role profile 303 is mapped to an object that may provide the cognitive data. There are two data stores that may provide the required cognitive data:

The first data store is the occupational model store 203. The occupational model store 203 holds a standardized set of over 2,000 occupations, with each occupation defined and described in an occupation object 307, also known as the occupation profile. Part of the profile includes a set of occupational cognitive metric(s) 371 that describe a standardized cognitive profile for each occupation. As part of the configuration of the talent optimization system 104, user(s) 101b from the company review the occupational profiles 307 and match them to the client role profile(s) 303 using the occupation mapping code 337, thus creating a link that provides the foundation of cognitive data for each of their client role profiles 303. The relationship between the client role profile(s) 303 and the occupational profile(s) 307 enables the calculation module 212 to build a descriptive model of the positions within a company using the standardized occupational cognitive metric(s) 371. User(s) 101a receives a catalyzr quotient 316 for profiles that use the occupational model store 203.

The second data store is the exemplar model store 204. The exemplar model store 204 holds cognitive data that has been generated by the system for a client role profile(s) 303 that have been identified by the reporting user 101b during the configuration of the talent optimization system 104 as “value added” or “differentiating” and thus requiring a customized and unique set of exemplar cognitive metric(s) 355. User(s) 101a receive a catalyzr quotient 317 for profiles that use the occupational model store 203. When a client role profile(s) 303 has an exemplar mapping code 339, the system may calculate both a catalyzr quotient 316 and an e_catalyzr quotient 317 for that profile so that users 101b may analyze the differences between the standard and idealized profile.

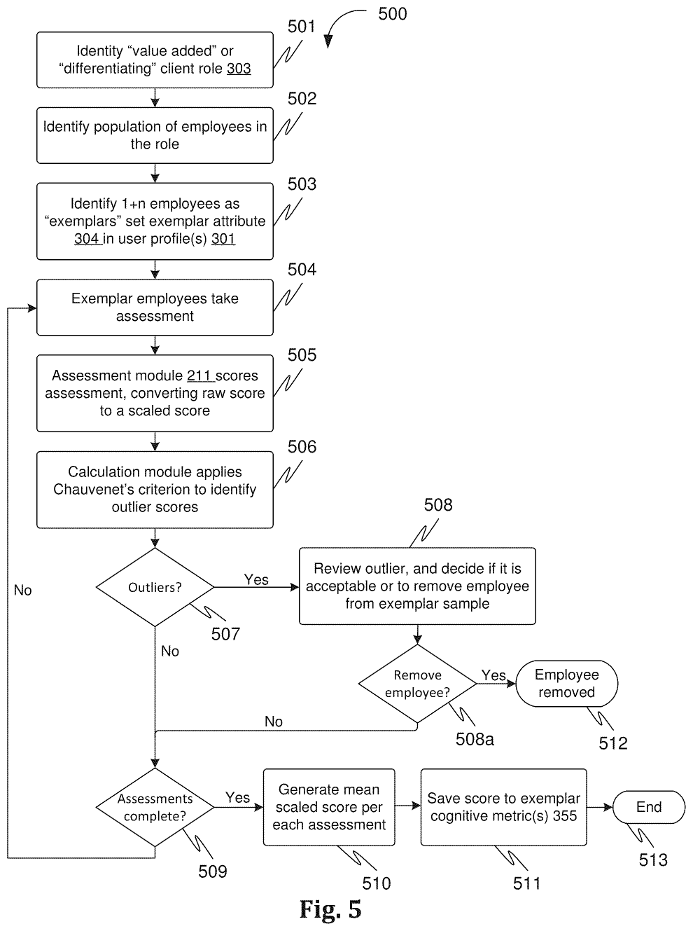

FIG. 5 is a flowchart of an exemplary method for creating an exemplar profile within the talent optimization system 104, in accordance with some embodiments.

Accordingly, FIG. 5 shows the method 500 for generating the customized exemplar profile 305 and the unique set of exemplar cognitive metric(s) 355. At step 501, a reporting user 101b identifies “value added” or “differentiating” client role profile 303. The reporting user 101b then identifies the total population of employees in the role at step 502. At step 503, using objective metrics, such as performance reviews, earnings, and manager recommendations, etc., the reporting user 101b identifies one or more (“n”) employees to be used as “exemplars”, by tagging the employees with the exemplar attribute 314 to the user profile(s) 301. After the exemplar employee completes the assessment at step 504, assessment module 211 scores the assessment, converting raw score to a scaled score for each employee 505. When all the exemplar employees have finished one assessment, the calculation module 212 applies Chauvenet's Criterion to identify outlier scores 506, Chauvenet's Criterion being defined below:

τ=|Xi−x̅|/s

Find the standardized deviation from the mean for all suspected outliers, data values “i”, where ‘x̅’ is the sample mean, and ‘s’ is the sample standard deviation. At step 507, if outliers exist, proceed to step 508, during which the user(s) 101b may review the outliers and decide to remove employee 512 from the sample. After the outlier check, the assessments may be assessed for completeness at step 509, and the calculation module generates a mean scaled score for each assessment based on the employee's scaled scores at step 510. At step 511, the calculation module then saves the assessment's mean scaled score to the exemplar cognitive metric(s) 355 that is held in the exemplar profile 305 stored in the exemplar model store 204, and associated with the organization 331 exemplar mapping code 339 stored in the client role profile 303 held in the client store 202.

Once the occupational model store 203 and exemplar model store 204 have been configured, the occupational model store 203 and exemplar model store 204 may be used for predictive analysis and forecasting. These predictive models may be used to assess factors including, for example, how likely the user(s) 101a would be to succeed in a particular role in the company. Accurate predictive models may detect subtle data patterns to answer questions about an employee's future performance to guide employers to optimize the human capital.

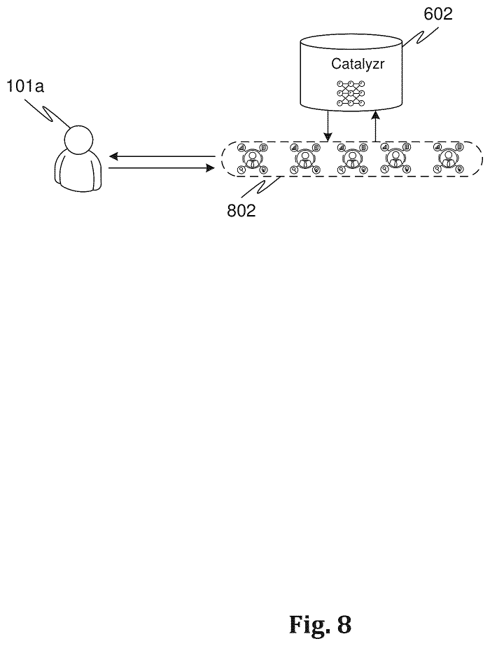

Recommendation Module 213: Once the calculation module is configured with the Occupational Model Store 203 and the Exemplar Model Store 204 (e.g. the client role profile mapped to the correct occupation profile, role profile exemplars identified, assessments taken, and exemplar profiles established), then the recommendation module may be used for predictive analysis and forecasting. For simplicity, the term “position” may be used instead of “client role profile” for this section. In a system of the disclosed system, the recommendation module provides user(s) 101a with two pieces of information: 1) a list of company positions, prioritized by catalyzr quotient 316, where the user(s) 101a's catalyzr quotient 316 shows a strong potential for success. A strong potential for success may be defined by a threshold value, for example, a catalyzr quotient score of >=70. The second piece of information provided by the recommendation module may be the average catalyzr quotient 316 for each of the prioritized positions. Using the information, the user(s) 101a may identify positions where they have the highest potential to succeed, but also where the user(s) 101a catalyzr quotient 316 may be larger than the average catalyzr quotient 316 for the position. In the way, the user(s) 101a may also decide where they might also have the largest impact. Each position listed in the list of company positions may be adapted with a flag, the flag being instanced based on the user. The flag may be used to keep track of when a user has “liked” a position, for example, by pressing an associated “like” button with the company position. When a user(s) 101a selects a position that they are interested in by “liking” it, the user(s) 101a may receive a set of skills self-assessments to complete. These skills are linked to the position that the user(s) 101a have indicated an interest in. Once completed, the self-assessment scores 313 may be stored in the user store 201 or a similar data storage medium. Based on the user(s) 101a's self-assessment, the talent optimization system 104 may recommend training in skills that the user(s) 101a needs to improve in to meet the requirements for position “readiness”. “Readiness” may be defined by some threshold value, may be defined by matching all skill qualifications, requirements, or recommendations for the role, or may be defined manually by a system administrator. As shown in FIG. 8, once a user has completed a learning or training exercise, the self-assessment may be updated to register the effects of the learning or training exercise, and any related self-assessment value may be updated accordingly.

In a system of the disclosed system, the recommendation module provides user(s) 101b who are affiliated with Human Resources activities (e.g., workforce planning, talent management, or recruitment sourcing) a list of the positions available in the talent optimization system 104. The list of positions has multiple filters available, including the different levels of the organization 331 that the position is assigned to. In the configuration, each position shows a catalyzr quotient 316 which is the average of all the employees who work in that position in that part of the organization 331. Selecting a link for a position that has a low catalyzr quotient, the user(s) 101b is presented with summary profiles of employees broken into three segments: “Exemplars”, “Incumbents” and “Potentials”. Each employee profile has indicative data in the employee profile including hire date, date of last promotion, and performance metrics, as well as the catalyzr quotient 316 for the current position. Exemplars are employees who were selected to provide inputs into the exemplar cognitive metric(s) 355 for the position. Incumbents are employees who are currently in the selected position. Potentials are employees who are in other positions but possess high catalyzr quotients for the position selected by the user 101b. The talent optimization system 104 recommends that the user 101b consider training or moving these Potentials into the selected position because these employees have a higher potential to be successful than the current incumbents. A move to the selected position would improve the average catalyzr quotient 316 for the position and increase the overall potential for success for the organization 331 that the position belongs to. The user 101b may decide to recommend the position to the employee and may do so through a recommendation message in the system that may appear in the employee's landing page.

In a system of the disclosed system, users 101b are provided with a list of the employees available in the talent optimization system 104 filterable by the different levels of the organization 331. In the configuration, the users 101b may review the employees and identify employees who have catalyzr quotients 316 that are below a threshold considered a strong match or potential for success (e.g., a catalyzr quotient <70). The system recommends to the user 101b positions where the employee has a high potential for success. The user 101b may review the position requirements as well as the skills required for the position and then may review the employee's self-assessed skills and capabilities to see if the employee may be considered “ready” or decide if the employee needs additional training. The user 101b may decide to recommend the position to the employee and may do so through a recommendation message in the system that may appear in the employee's landing page.

Methods of a System of the Disclosed system: The talent optimization system 104 focuses on cognitive assessments that measure different elements of General Mental Ability (GMA), as assessments of GMA have been found to be one of the most valid construct-based predictors of job performance and training success. Professor Frank Schmidt posited that the measurement of two, three, or specific aptitudes (e.g., verbal, numerical, and spatial) is a de facto measure of GMA. Assessments found in the talent optimization system 104 capture not only the core elements of GMA but also elements of other areas that have been shown to increase the predictive power of GMA when the assessments are assessed in conjunction with GMA. These elements may be presented in the form of a periodic table of potential.

FIG. 4 is an illustration of elements of General Mental Ability that may be assessed in the talent optimization system 104, in accordance with some embodiments.

Accordingly, Cognitive assessments may comprise measuring General Mental Ability, which may include arithmetic reasoning, verbal aptitude, spatial aptitude, perceptual speed, critical thinking, and problem-solving.

Non-limiting examples of cognitive assessments that produce cognitive assessment scores 311 that may be part of the talent optimization system 104 include elements illustrated in FIG. 4, wherein the cognitive assessment assesses the candidate based on the:

Example 1—Quantitative Abilities: The quantitative abilities assessment measures such as mathematical reasoning and number facility to solve problems in everyday situations. The quantitative abilities assessment involves gathering and sorting through all information related to a problem, making educated guesses about how best to solve the problem, and picking a likely way to solve it.

In the disclosed system, user(s) 101a are presented with an assessment of arithmetic reasoning containing 18 questions that become progressively harder as the assessment progresses and must be completed within 20 minutes. The assessment consists of mathematical word problems requiring addition, subtraction, multiplication, or division of whole numbers, fractions, and percentages.

Example 2—Verbal Aptitude: The Verbal aptitude assessment measures oral comprehension and written comprehension. Assessing the ability to understand the meaning of words and using them correctly in good communication.

In the disclosed system, the user(s) 101a are presented with 19 questions which must be completed within 8 minutes. The assessment consists of indicating which two words out of four have either the same or opposite meanings.

Example 3—Spatial Aptitude: The spatial aptitude assessment measures spatial orientation and visualization abilities. The spatial aptitude assessment involves easily understanding how drawings represent real objects and correctly imagining how parts fit together.

In the disclosed system, the user(s) 101a are presented with 20 questions which must be completed within 8 minutes. The assessment consists of determining which one of four three-dimensional figures may be made by bending and/or rolling a flat, two-dimensional form.

Example 4—Perceptual Aptitude: The perceptual aptitude assessment measures perceptual speed and elements of conscientiousness such as attention to detail. Perceptual speed is the ability to compare similarities and differences quickly and accurately among sets of letters, numbers, objects, pictures, or patterns. The things to be compared may be presented at the same time or one after the other. The ability also includes comparing a presented object with a remembered object.

In the disclosed system, the user(s) 101a are presented with 90 questions which must be completed within 6 minutes. The assessment consists of determining whether two names are the same or different.

Example 5—Pattern Recognition: The pattern recognition test measures “fluid” cognitive abilities and does not require language or much by way of acquired knowledge to solve the problems. These fluid abilities are most related to pattern recognition and deductive reasoning as well as speed of closure and flexibility of closure. Speed of closure is the ability to quickly make sense of, combine, and organize information into meaningful patterns. The flexibility of closure is the ability to identify or detect a known pattern (a figure, object, word, or sound) that is hidden in other distracting material.

The most comprehensive review of the validity of the type of employment test was conducted by Postlethwaite based on the results of dozens of studies and thousands of job candidates. The review showed that scores have a strong statistical relationship to job performance. Moreover, problem-solving predicts job success beyond other prerequisites, such as work experience and employment interviews.

In the present disclosed system, an assessment of non-verbal reasoning is used. Such an assessment may be (but is not limited to) as assessment like Raven's Progressive Matrices where the user(s) 101a is presented with 90 images. Each image is a pattern with one section missing. The user(s) 101a must choose from a slate of six to eight pattern options which one option would correctly complete the pattern in the grid. The patterns become harder as the test progresses as the assessment progresses and must be completed within 20 minutes.

For any of the above-timed assessments, if the user(s) 101a leaves the assessment, the timer continues and the user(s) 101a may return to complete the assessment in the time remaining. At the end of the time, the assessment is closed, and the score is calculated.

Example 6—Values: The values assessment is based on the Theory of Work Adjustment (TWA) which says that the degree to an individual's skills and abilities align to the skill and ability requirements of the work being done may predict the individual's satisfactoriness to do the work; whereas the degree that an individual's needs and values and the reinforces available in the work environment may predict an individual's satisfaction with the work they are doing.

In the present disclosed system, the user(s) 101a is asked to prioritize 21 “need statements’ about the ideal work environment. After completing the prioritization exercise the user(s) 101a rates each need statement as either important or not important. The output of the assessment is to calculate and inform the participant of the top two work values. These Work Values are then included in the machine learning algorithm that calculates the catalyzr quotient 316 so that positions that match these values are given more weight than those that do not.

Embodiments: The following non-limiting embodiments provide illustrative examples of the disclosed system, but do not limit the scope of the disclosed system.

In one embodiment, a company would use a core set of preconfigured cognitive assessments.

In another embodiment of the disclosed system, a company may wish to include additional cognitive assessments as a supplement to the core set of cognitive assessments.

In one embodiment, companies may choose to use the standardized cognitive data in the occupational profiles for all of the positions in the talent optimization system 104. In the embodiment, when the calculation module calculates the catalyzr quotient for a user(s) and a client role profile; the calculator module uses the cognitive assessment score(s) and cognitive metric(s) that the client role profile has inherited from the occupation profile that was mapped as part of the configuration of the talent optimization system for the company. After the calculation module has calculated a catalyzr quotient for the client role profile for the user(s) 101a, the calculation module may move to the next client role profile and calculate a catalyzr quotient for the assessment taker 101a and that client role profile. The process may continue until the calculation module has calculated a catalyzr quotient for the users(s) 101a and every client role profile in the talent optimization system 104. In this way, the calculation module provides the users(s) 101a with a metric that describes the potential for success for every position in the company and enables the users(s) 101a to make data-driven career decisions. The user(s) 101b are provided metrics on the users(s) 101a potential for success for every position in the company that may be used for workforce planning, learning and development, hiring, and 10 mobility.

In another embodiment, a company may use the occupational profiles for positions that the company considers to be “non-differentiating” or for positions where the company does not have a large enough population to draw a statistically significant group of employees who could be used as the foundation for an exemplar profile. Where the company may identify positions that are considered “value added” or “differentiating” and/or where there is a large enough population to draw a statistically significant group of employees, companies may create exemplar profiles and use both occupational profiles and exemplar profiles in the talent optimization system configuration. When the calculation module calculates the catalyzr quotient for a user(s) 101a and a client role profile; the calculation module completes two sets of calculations. The first set uses the cognitive assessment scores and the standardized cognitive data in the occupational profiles (as described in another embodiment) for all client role profiles, producing a catalyzr quotient for a user(s) 101a and each client role profile. The second calculation uses the cognitive assessment score(s) and exemplar cognitive metric(s) that the client role profile has inherited from the exemplar profile that was mapped as part of the configuration of the talent optimization system 104 for the company to create the catalyzr quotient. The process may continue until calculation module has calculated a catalyzr quotient for the user(s) 101a and every client role profile in the talent optimization system 104 that has been mapped to an exemplar profile. The user(s) 101a may receive only catalyzr quotients for the client role profiles associated with an exemplar profile as this is considered the ideal profile model by the company. For all other client role profiles, the user(s) 101a may receive the catalyzr quotient. The user(s) 101a is provided with a metric that describes the potential for success for every position in the company and enables the user(s) 101a to make data-driven career decisions.

In this embodiment, the user(s) 101b are provided metrics on the user(s) 101a potential for success in using the exemplar profiles that make the client role profile unique. User(s) 101b, may also have access to the metrics that are the result of the calculations using the occupation profile and the client role profile. This allows user(s) 101b to use multiple analytical models when engaging in workforce planning, learning and development, hiring, and mobility activities.

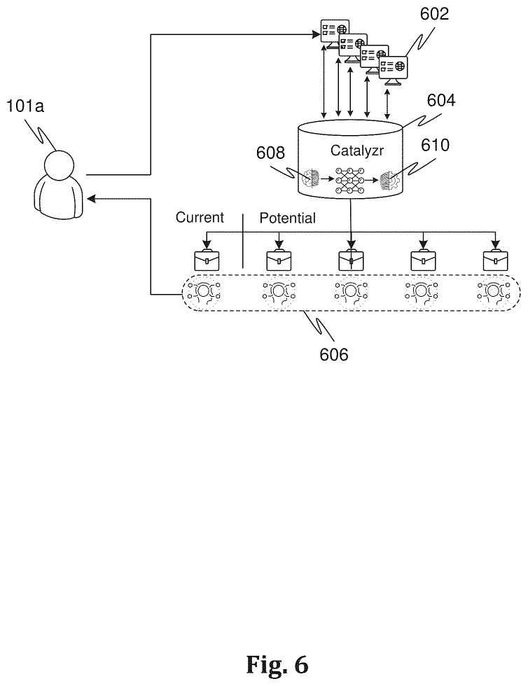

FIG. 6 is a flow diagram of an exemplary first method showing a method of use for the talent optimization system 104, in accordance with some embodiments.

Accordingly, the user 101a completes a series of online cognitive assessments 602 to create a unique Cognitive Fingerprint for the user 101a. A Catalyzr 604 including the talent optimization system 104 compares the cognitive fingerprint to either 1) a generic job/role/occupation profile 608, or 2) an “exemplar profile 610 consists of the combined cognitive profiles of individuals identified by company as successful. The Catalyzr 604 further provides a summary of the correlation between the attributes of the cognitive fingerprint and the role profile as presented in a single number/metric called the Catalyzr Quotient 606 that represents jobs/roles/occupations within an organization.

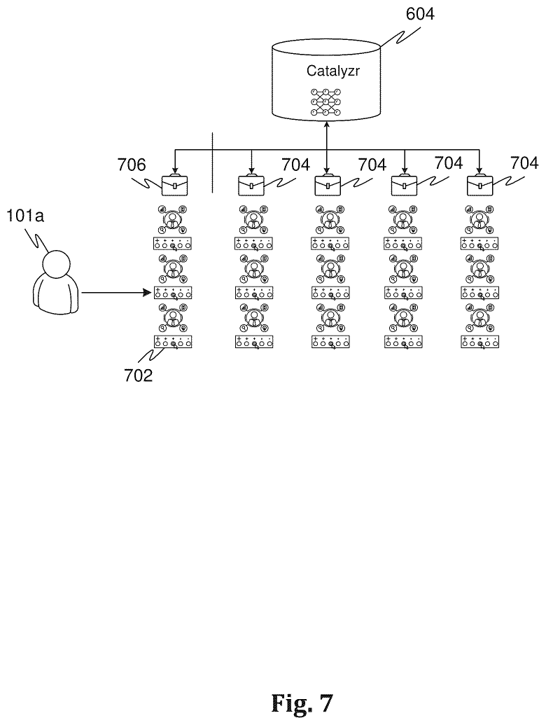

FIG. 7 is a flow diagram of an exemplary second method showing a method of use for the talent optimization system 104, in accordance with some embodiments.

Accordingly, the Catalyzr 604 identifies skills that are associated with User 101a current job/role/occupation 706 as well as for those skills 702 associated with jobs/roles/occupations that are indicated as high potential 704 by the Catalyzr Quotient. The User 101a self-assesses of the level of capability for each of the skills 702. The individual's self-assessed skills 702 are saved to a database.

FIG. 8 is a flow diagram of an exemplary third method showing a method of use for the talent optimization system 104, in accordance with some embodiments.

Accordingly, the catalyzr 604 recommends learning and development activities 802 for skills 702 that the user 101a needs to improve the capabilities in preparation for a given job/role/occupation that the user 101a has indicated they are interested in. Further, when the user 101a has completed the learning exercise, they then update the self-assessment to register the increased capability in that skill 702.

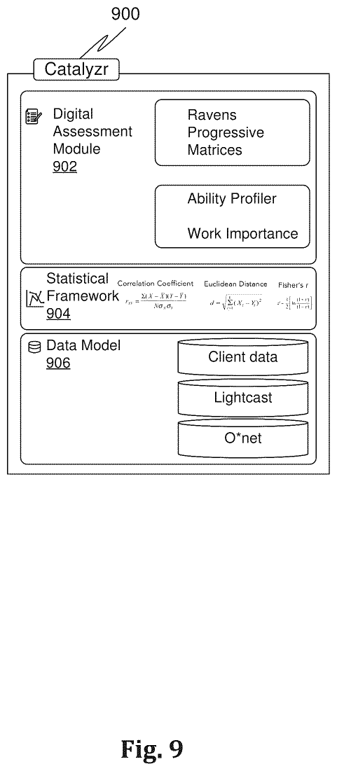

FIG. 9 is a block diagram showing an exemplary embodiment of the system of the application.

Accordingly, System 900, also referred to as Catalyzr, comprises a Digital Assessment Module 902 that is configured to assess the skills of the user. The digital assessment module 902 is configured to conduct assessments comprising Raven Progressive matrices, additional cognitive assessments including a battery of tests, digitalized paper and pencil assessments, and result calculation. The digital assessment module 902 further comprises an ability profiler configured to streamline assessment only for General Mental Ability related occupational descriptors. The digital assessment module 902 is configured to generate a cognitive fingerprint of the user based on the assessments.

Further, the system 900 comprises a data model 906 configured to store at least one data associated with the client job architecture, client skills library, market driven skills attached to O.net Job codes. The data model 906 is refreshed quarterly.

Further, the system 900 comprises a statistical framework 904 configured to integrate revised assessments to data model. The statistical framework 904 further generates a Catalyze Quotient based on the at least one data stored in the data model 906 and the cognitive fingerprint generated by the digital assessment module 902.

While preferred embodiments of the present disclosure have been shown and described herein, it will be obvious to those skilled in the art that such embodiments are provided by way of example only and that other uses may be applied to the disclosed system.

Although the disclosed system has been explained in relation to its preferred embodiment, it is to be understood that many other possible modifications and variations may be made without departing from the spirit and scope of the disclosed system.

Further, the present disclosure describes a system and method for a talent optimization system 104 used by companies to assist in a skill-based workforce planning process. The system may be used by the company to assist in the learning and training process to identify skill gaps and training needs. The system may be used by companies in the recruitment sourcing process to identify individuals for positions within the company based on a quantitative model of potential success. Additionally, the system may be used to determine ideal positions within the company where the user has the highest potential for success as part of the individual's career development process. The system employs an array of cognitive science and skill assessments to assess a user's cognitive abilities and skills, after which the systems and methods may provide career & skill development recommendations to the user or report on the user's potential for success for one or more positions, as well as the current skills and skill development needs of the user to a company.

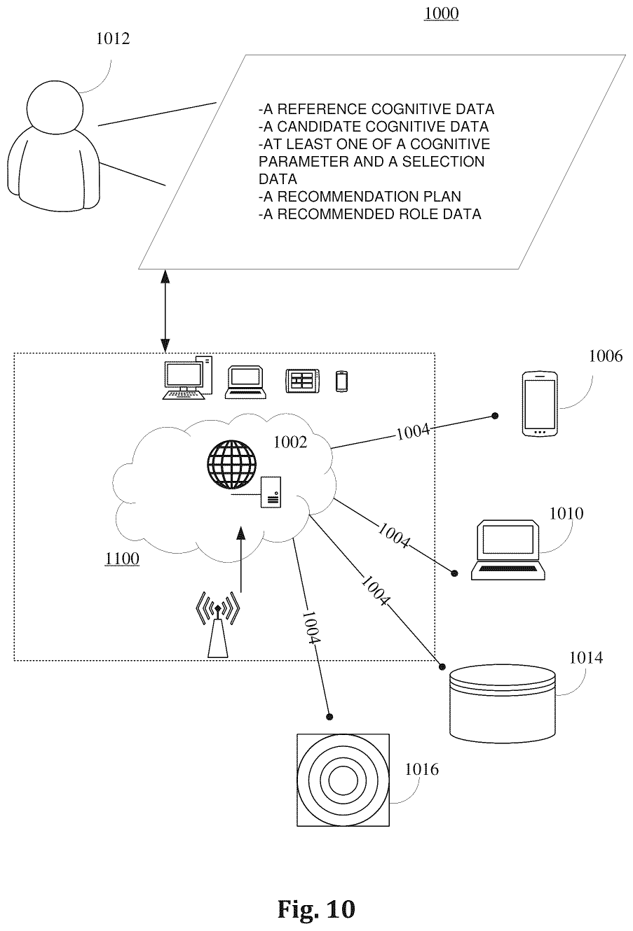

FIG. 10 is an illustration of an online platform 1000 consistent with various embodiments of the present disclosure. By way of non-limiting example, the online platform 1000 to facilitate assessment of a suitability may be hosted on a centralized server 1002, such as, for example, a cloud computing service. The centralized server 1002 may communicate with other network entities, such as, for example, a mobile device 1006 (such as a smartphone, a laptop, a tablet computer, etc.), other electronic devices 1010 (such as desktop computers, server computers, etc.), databases 1014, and sensors 1016 over a communication network 1004, such as, but not limited to the Internet. Further, users of the online platform 1000 may include relevant parties such as, but not limited to, end-users, administrators, service providers, service consumers, clients, entities, candidates, and so on. Accordingly, in some instances, electronic devices operated by the one or more relevant parties may be in communication with the platform.

A user 1012, such as the one or more relevant parties, may access online platform 1000 through a web based software application or browser. The web based software application may be embodied as, for example, but not be limited to, a website, a web application, a desktop application, and a mobile application compatible with a computing device 1100.

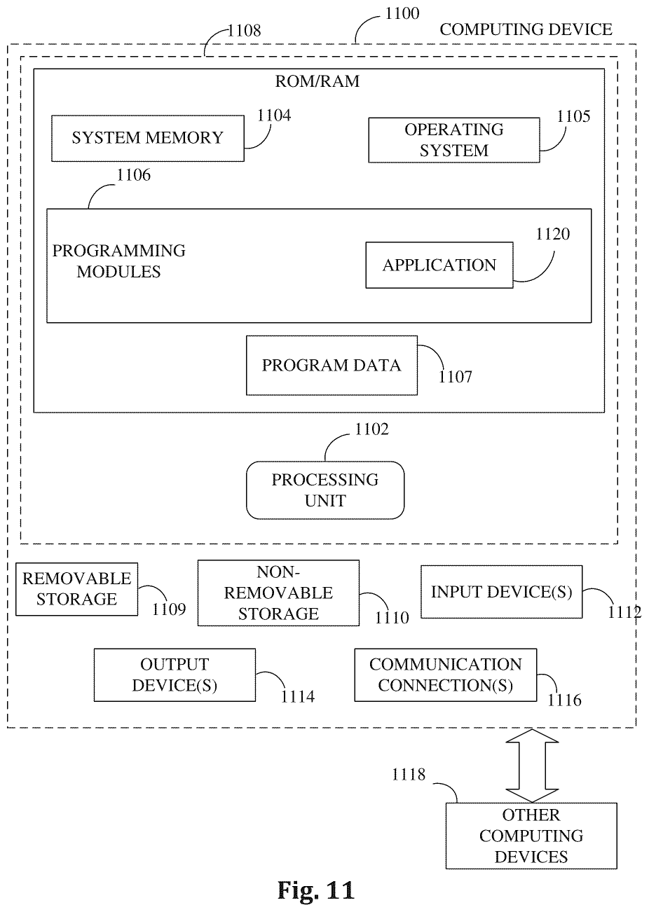

With reference to FIG. 11, a system consistent with an embodiment of the disclosure may include a computing device or cloud service, such as computing device 1100. In a basic configuration, computing device 1100 may include at least one processing unit 1102, and a system memory 1104. Depending on the configuration and type of computing device, system memory 1104 may comprise, but is not limited to, volatile (e.g. random-access memory (RAM)), non-volatile (e.g. read-only memory (ROM)), flash memory, or any combination. System memory 1104 may include operating system 1105, one or more programming modules 1106, and may include a program data 1107. Operating system 1105, for example, may be suitable for controlling computing device 1100′s operation. In one embodiment, programming modules 1106 may include image-processing module, machine learning module. Furthermore, embodiments of the disclosure may be practiced in conjunction with a graphics library, other operating systems, or any other application program and is not limited to any particular application or system. This basic configuration is illustrated in FIG. 11 by those components within a dashed line 1108.

Computing device 1100 may have additional features or functionality. For example, computing device 1100 may also include additional data storage devices (removable and/or non-removable) such as, for example, magnetic disks, optical disks, or tape. Such additional storage is illustrated in FIG. 11 by a removable storage 1109 and a non-removable storage 1110. Computer storage media may include volatile and non-volatile, removable, and non-removable media implemented in any method or technology for storage of information, such as computer-readable instructions, data structures, program modules, or other data. System memory 1104, removable storage 1109, and non-removable storage 1110 are all computer storage media examples (i.e., memory storage.) Computer storage media may include but is not limited to, RAM, ROM, electrically erasable read-only memory (EEPROM), flash memory or other memory technology, CD-ROM, digital versatile disks (DVD), or other optical storage, magnetic cassettes, magnetic tape, magnetic disk storage or other magnetic storage devices, or any other medium which can be used to store information and which can be accessed by computing device 1100. Any such computer storage media may be part of device 1100. Computing device 1100 may also have input device(s) 1112 such as a keyboard, a mouse, a pen, a sound input device, a touch input device, a location sensor, a camera, a biometric sensor, etc. Output device(s) 1114 such as a display, speakers, a printer, etc. may also be included. The aforementioned devices are examples and others may be used.

Computing device 1100 may also contain a communication connection 1116 that may allow device 1100 to communicate with other computing devices 1118, such as over a network in a distributed computing environment, for example, an intranet or the Internet. Communication connection 1116 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1104, including operating system 1105. While executing on processing unit 1102, programming modules 1106 (e.g., application 1120 such as a media player) may perform processes including, for example, one or more stages of methods, algorithms, systems, applications, servers, and databases as described above. The aforementioned process is an example, and processing unit 1102 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

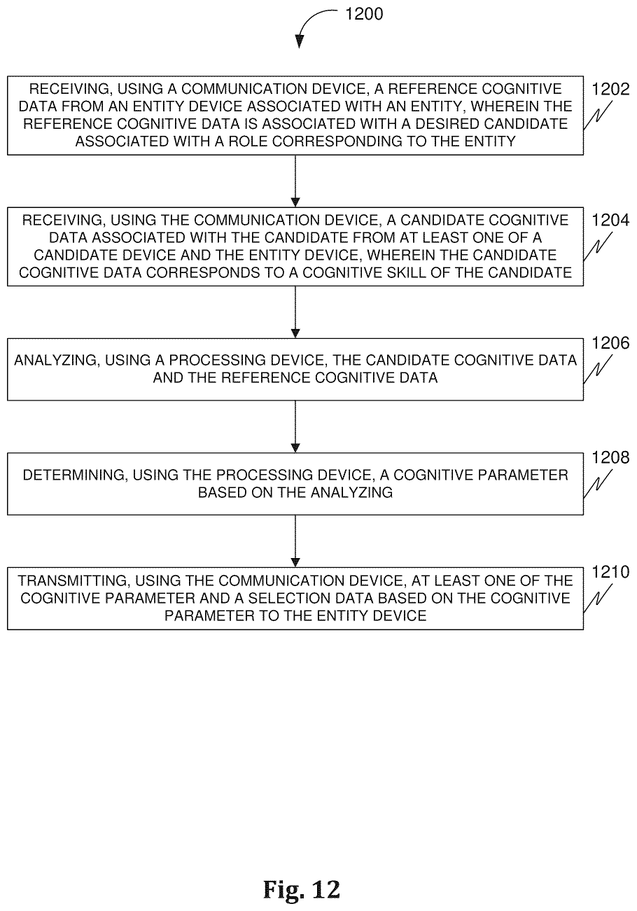

FIG. 12 illustrates a flowchart of a method 1200 of facilitating assessment of a suitability, in accordance with some embodiments.

In some embodiments, the assessment of a suitability of a candidate for a role comprises assessment of the candidate for recruiting for the role corresponding to an entity. In some embodiments, the recruiting of the candidate includes one or more of assigning the role to the candidate. In some embodiments, the candidate includes one or more of an existing employee associated with the entity and a new candidate.

Accordingly, the method 1200 may include a step 1202 of receiving, using a communication device 1502, a reference cognitive data from an entity device associated with an entity.

In some embodiments, the communication device 1502 may be a hardware device which may be configured to one or more of transmit and receive a data. In some embodiments, the communication device 1502 may be configured to one or more of transmit and receive the data wirelessly.

In some embodiments, the reference cognitive data may be based on a reference response data corresponding to a reference assessment data. Further, the reference response data may be provided by two or more desired candidates associated with the role. In some embodiments, the reference cognitive data includes a standard cognitive data associated with a desired cognitive skills data associated with the role. In some embodiments, the standard cognitive data includes a standardized set of skills associated with the role.

In some embodiments, the entity device includes one or more of a smart device, a personal computer, and a smartphone.

In some embodiments, the entity includes one or more of a business, a company, and a group of people.

Further, the reference cognitive data may be associated with a desired candidate associated with the role corresponding to the entity.

In some embodiments, the desired candidate includes one or more of a current employee associated with the role and the entity, and a past employee associated with the entity.

Further, the method 1200 may include a step 1204 of receiving, using the communication device 1502, a candidate cognitive data associated with the candidate from one or more of a candidate device and the entity device.

In some embodiments, each of the candidate cognitive data and the reference cognitive data corresponds to two or more cognitive skills comprising an attention span, a perceptive skill, a memory skill, a logical reasoning skill, a problem solving skill, and a processing skill. In some embodiments, the candidate cognitive data may be based on a response corresponding to a set of preconfigured cognitive assessments. Further, the response may be generated by the candidate.

In some embodiments, the candidate device includes one or more of a smart device, a personal computer, and a smartphone.

Further, the candidate cognitive data corresponds to a cognitive skill of the candidate. Further, the method 1200 may include a step 1206 of analyzing, using a processing device 1504, the candidate cognitive data and the reference cognitive data.

In some embodiments, the processing device 1504 includes an electronic device which may be configured to execute a set of instructions.

In some embodiments, the analysis of the reference cognitive data and the candidate cognitive data may be based on a machine learning model which may be configured to determine a pattern associated with the reference cognitive data and the candidate cognitive data. In some embodiments, the machine learning model includes a supervised learning model, an unsupervised learning model, a semi-supervised learning model, and a reinforcement learning model.

Further, the method 1200 may include a step 1208 of determining, using the processing device 1504, a cognitive parameter based on the analyzing.

In some embodiments, the cognitive parameter includes a numeric value indicative of a cognitive skill of the candidate. Further, the candidate cognitive data corresponds to the cognitive skill. In some embodiments, the numeric value may be in range of 0 to 100.

Further, the method 1200 may include a step 1210 of transmitting, using the communication device 1502, one or more of the cognitive parameter and a selection data based on the cognitive parameter to the entity device.

In some embodiments, the selection data may be based on a criterion.

In some embodiments, the processing device 1504 may be further configured to generate a scaled score corresponding to reference response data corresponding to each of the two or more desired candidates. Further, a reference cognitive data may be generated using the scaled score based on a criterion and a mean of the scaled score. In some embodiments, the criterion includes a Chauvenet's Criterion.

In some embodiments, the method 1200 may further include identifying, using the processing device 1504, the candidate cognitive data as the reference cognitive data based on a reference criterion.

In some embodiments, the method 1200 may further include transmitting, using the communication device 1502, the cognitive parameter to the candidate device.

In some embodiments, the method 1200 may further include transmitting, using the communication device 1502, a candidate assessment data to at one of the candidate device and the entity device.

In some embodiments, the candidate assessment data includes a General Mental Ability assessment data. In some embodiments, the GMA assessment data includes an assessment associated with one or more of a quantitative ability, a verbal aptitude, a spatial aptitude, a perceptual speed, a critical thinking skill and a problem solving skill, a value parameter, a pattern recognition skill.

Further, each of the candidate device and the entity device includes an end processing device, an end communication device, and an end presentation device. Further, the end presentation device may be configured to present the candidate assessment data to the candidate. Further, the candidate cognitive data may be based on a response corresponding to the candidate cognitive assessment. Further, the response may be generated by the candidate.

In some embodiments, the method 1200 may further include receiving, using the communication device 1502, a cognitive sensor from one or more of a candidate device and the entity device. Further, each of the candidate device and the entity device includes a sensor which may be configured to generate the cognitive sensor data associated with the cognitive skill of the candidate.

In some embodiments, the standard cognitive data may be received from two or more databases which may be configured to store the standard cognitive data.

In some embodiments, the role includes two or more roles associated with the entity. Further, the processing device 1504 may be configured to determine the cognitive parameter corresponding to each role of the two or more roles. Further, the communication device 1502 may be further configured to transmit each of the cognitive parameter to one or more of the candidate device and the entity device. In some embodiments, the two or more roles may be arranged in a specified order based on a criterion associated with each of the cognitive parameter.

In some embodiments, the method 1200 may further include transmitting, using the communication device 1502, a reference assessment data to one or more of the candidate device and the entity device. Further, each of the candidate device and the entity device includes an end processing device, an end communication device, and an end presentation device. Further, the end presentation device may be configured to present the reference assessment data to the candidate. Further, the reference cognitive data may be based on a response corresponding to the reference assessment data. Further, the response may be generated by the candidate associated with the role.

In some embodiments, the method 1200 may further include storing, using a storage device, the reference cognitive data, and the candidate cognitive data. Further, the processing device 1504 may be further configured to one or more of search, analyze, and retrieve data stored in the storage device. In some embodiments, the storage device includes a non-volatile memory.

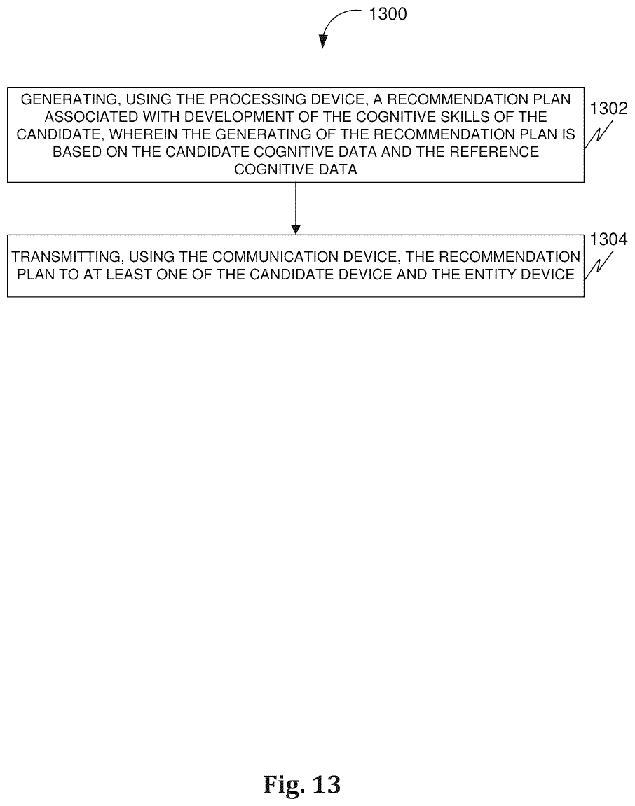

FIG. 13 illustrates a flowchart of a method 1300 of facilitating assessment of a suitability including generating, using the processing device 1504, a recommendation plan associated with development of the cognitive skills of the candidate, in accordance with some embodiments.

Further, in some embodiments, the method 1300 may include a step 1302 of generating, using the processing device 1504, a recommendation plan associated with development of the cognitive skills of the candidate. Further, the generating of the recommendation plan may be based on the candidate cognitive data and the reference cognitive data. Further, in some embodiments, the method 1300 may include a step 1304 of transmitting, using the communication device 1502, the recommendation plan to one or more of the candidate device, and the entity device.

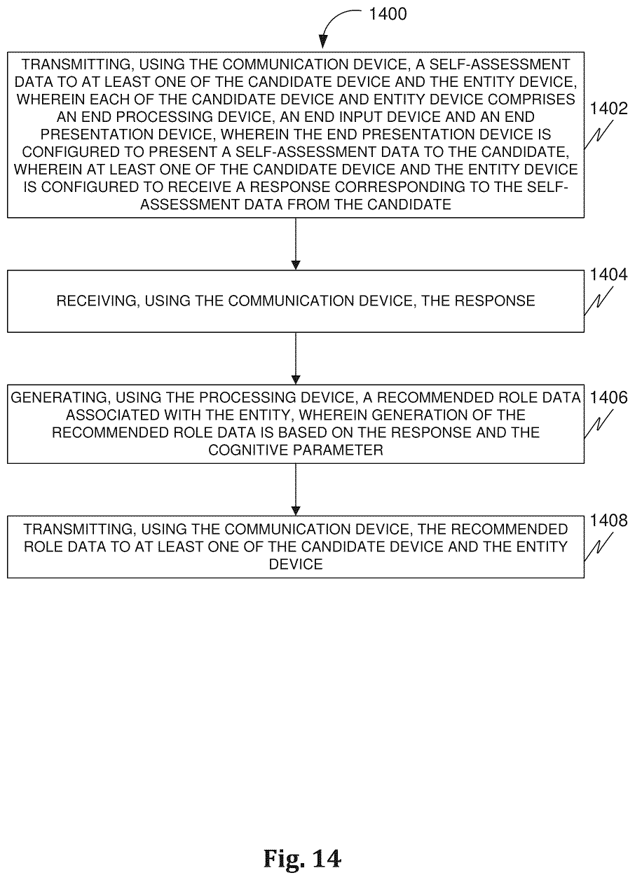

FIG. 14 illustrates a flowchart of a method 1400 of facilitating assessment of a suitability including generating, using the processing device 1504, a recommended role data associated with the entity, in accordance with some embodiments.

Further, in some embodiments, the method 1400 may include a step 1402 of transmitting, using the communication device 1502, a self-assessment data to one or more of the candidate device and the entity device. Further, each of the candidate device and entity device includes an end processing device, an end input device, and an end presentation device. Further, the end presentation device may be configured to present a self-assessment data to the candidate. Further, one or more of the candidate device and the entity device may be configured to receive a response corresponding to the self-assessment data from the candidate. Further, in some embodiments, the method 1400 further may include a step 1404 of receiving, using the communication device 1502, the response. Further, in some embodiments, the method 1400 further may include a step 1406 of generating, using the processing device 1504, a recommended role data associated with the entity. Further, generation of the recommended role data may be based on the response and the cognitive parameter. Further, in some embodiments, the method 1400 further may include a step 1408 of transmitting, using the communication device 1502, the recommended role data to one or more of the candidate device and the entity device.

In some embodiments, the transmission of a recommended role data may be based on a criterion. In some embodiments, the criterion includes a threshold.

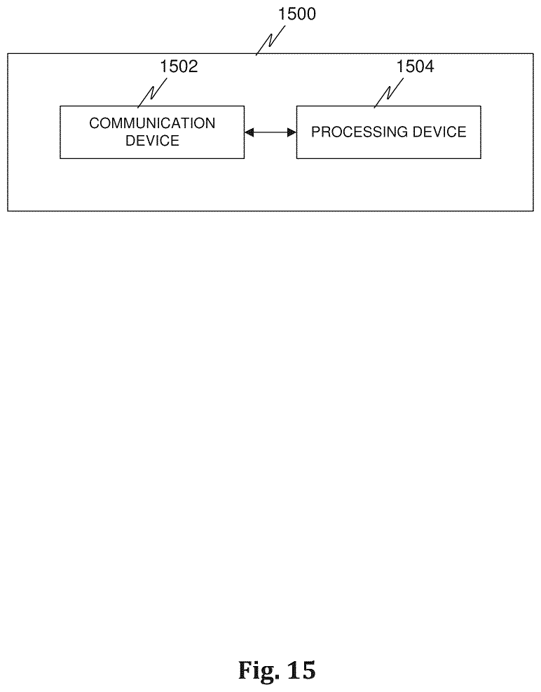

FIG. 15 illustrates a block diagram of a system 1500 of facilitating assessment of a suitability, in accordance with some embodiments.

Accordingly, the system 1500 may include a communication device 1502. Further, the communication device 1502 may be configured to receive a reference cognitive data from an entity device associated with an entity. Further, the reference cognitive data may be associated with a desired candidate associated with a role corresponding to the entity. Further, the communication device 1502 may be configured to receive a candidate cognitive data associated with the candidate from one or more of a candidate device and the entity device. Further, the candidate cognitive data corresponds to a cognitive skill of the candidate. Further, the communication device 1502 may be configured to transmit one or more of a cognitive parameter and a selection data associated with the cognitive parameter to the entity device. Further, the system 1500 may include a processing device 1504 communicatively coupled with the communication device 1502. Further, the processing device 1504 may be configured to analyze the candidate cognitive data and the reference cognitive data. Further, the processing device 1504 may be configured to determine a cognitive parameter based on the analyzing.

In some embodiments, each of the candidate cognitive data and the reference cognitive data corresponds to two or more cognitive skills comprising an attention span, a perceptive skill, a memory skill, a logical reasoning skill, a problem solving skill, and a processing skill. In some embodiments, the candidate cognitive data may be based on a response corresponding to a set of preconfigured cognitive assessments. Further, the response may be generated by the candidate.

In some embodiments, the communication device 1502 may be further configured to transmit a candidate assessment data to at one of the candidate device and the entity device. Further, each of the candidate device and the entity device includes an end processing device, an end communication device and an end presentation device. Further, the end presentation device may be configured to present the candidate assessment data to the candidate. Further, the candidate cognitive data may be based on a response corresponding to the candidate cognitive assessment. Further, the response may be generated by the candidate.

In some embodiments, the reference cognitive data includes a standard cognitive data associated with a desired cognitive skills data associated with the role.

In some embodiments, the processing device 1504 may be further configured to generate a recommendation plan associated with development of the cognitive skills of the candidate. Further, the generating of the recommendation plan may be based on the candidate cognitive data and the reference cognitive data. Further, the communication device 1502 may be further configured to transmit the recommendation plan to one or more of the candidate device and the entity device.

In some embodiments, the communication device 1502 may further configured to receive a cognitive sensor from one or more of a candidate device and the entity device. Further, each of the candidate device and the entity device includes a sensor which may be configured to generate the cognitive sensor data associated with the cognitive skill of the candidate.

In some embodiments, the role includes two or more roles associated with the entity. Further, the processing device 1504 may be further configured to determine the cognitive parameter corresponding to each role of the two or more roles. Further, the communication device 1502 may be further configured to transmit each of the cognitive parameter to one or more of the candidate device and the entity device.

Further, in some embodiments, the communication device 1502 may be further configured to transmit a self-assessment data to one or more of the candidate device and the entity device. Further, each of the candidate device and entity device includes an end processing device and an end presentation device. Further, the end presentation device may be configured to present a self-assessment data to the candidate. Further, one or more of the candidate device and the entity device may be configured to receive a response corresponding to the self-assessment data from the candidate. Further, the communication device 1502 may be further configured to receive the response. Further, the processing device 1504 may be further configured to generate a recommended role data associated with the entity. Further, generation of the recommended role data may be based on the response and the cognitive parameter. Further, the communication device 1502 may be further configured to transmit the recommended role data to one or more of the candidate device and the entity device.

In some embodiments, the communication device 1502 may be further configured to transmit a reference assessment data to one or more of the candidate device and the entity device. Further, each of the candidate device and the entity device includes an end processing device, an end communication device, and an end presentation device. Further, the end presentation device may be configured to present the reference assessment data to the candidate. Further, the reference cognitive data may be based on a response corresponding to the reference assessment data. Further, the response may be generated by the candidate associated with the role.

In some embodiments, the system 1500 may be further a storage device which may be configured to store the reference cognitive data and the candidate cognitive data. Further, the processing device 1504 may be further configured to one or more of search, analyze, and retrieve data stored in the storage device.

In some embodiments, the analysis of the reference cognitive data and the candidate cognitive data may be based on a machine learning model which may be configured to determine a pattern associated with the reference cognitive data and the candidate cognitive data.

Further, in accordance with some embodiments, the following aspects are also provided.

1. A method of facilitating an assessment of a suitability of a candidate for a role, comprising: receiving, using a communication device, reference cognitive data from an entity device associated with an entity, wherein the reference cognitive data is associated with a desired candidate associated with a role corresponding to the entity; receiving, using the communication device, candidate cognitive data associated with the candidate from at least one of a candidate device and the entity device, wherein the candidate cognitive data corresponds to a cognitive skill of the candidate; analyzing, using a processing device, the candidate cognitive data and the reference cognitive data; determining, using the processing device, a cognitive parameter based on the analyzing; and transmitting, using the communication device, at least one of the cognitive parameter and selection data based on the cognitive parameter to the entity device.

2. The method of aspect 1, wherein the analysis of the reference cognitive data and the candidate cognitive data is based on a machine learning model configured to determine a pattern associated with the reference cognitive data and the candidate cognitive data, wherein the machine learning model is a linear regression algorithm.

3. The method of aspect 1, wherein the reference cognitive data is based on a reference response data corresponding to a reference assessment data, wherein the reference response data is provided by a plurality of desired candidates associated with the role, wherein the plurality of desired candidates is identified as exemplars by the entity.

4. The method of aspect 1 further comprising generating, using the processing device, a recommendation plan associated with the development of the cognitive skills of the candidate, wherein the generating of the recommendation plan is based on the candidate cognitive data and the reference cognitive data; and transmitting, using the communication device, the recommendation plan to at least one of the candidate device and the entity device.

5. The method of aspect 1 further comprising: transmitting, using the communication device, skill-related self-assessment data to at least one of the candidate device and the entity device, wherein each of the candidate device and entity device comprises an end processing device, an end input device and an end presentation device, wherein the end presentation device is configured to present a self-assessment data to the candidate, wherein at least one of the candidate device and the entity device is configured to receive a response corresponding to the self-assessment data from the candidate; receiving, using the communication device, the response; generating, using the processing device, a recommended role data associated with the entity, wherein generation of the recommended role data is based on the response and the cognitive parameter; and transmitting, using the communication device, the recommended role data to at least one of the candidate device and the entity device.

6. The method of aspect 1, wherein the transmission of the recommended role data is based on a criterion, wherein the criterion comprises a threshold.

7. The method of aspect 1, wherein the processing device is further configured to generate a scaled score corresponding to the reference response data corresponding to each of the plurality of desired candidates, wherein the reference cognitive data is generated using the scaled score based on a criterion and a mean of the scaled score, wherein the criterion comprises the Chauvenet's Criterion.

8. The method of aspect 1 further comprising identifying, using the processing device, the candidate cognitive data as the reference cognitive data based on a reference criterion.

9. The method of aspect 1 further comprising transmitting, using the communication device, the cognitive parameter to the candidate device.

10. The method of aspect 3 further comprising transmitting, using the communication device, the candidate assessment data to at least one of the candidate device and the entity device.

11. The method of aspect 10, wherein the candidate assessment data comprises a General Mental Ability assessment data, wherein the GMA assessment data comprises an assessment associated with at least one set of aptitudes and abilities: quantitative ability, verbal aptitude, spatial aptitude, perceptual speed, critical thinking, problem-solving, non-verbal reasoning, and/or pattern recognition.

12. The method of aspect 10, wherein each of the candidate device and the entity device comprises an end processing device, an end communication device, and an end presentation device, wherein the end presentation device is configured to present the candidate assessment data to the candidate, wherein the candidate cognitive data is based on a response corresponding to the candidate cognitive assessment, wherein the response is generated by the candidate.

13. The method of aspect 1, wherein the standard cognitive data is received from a plurality of databases configured to store the standard cognitive data.

14. The method of aspect 1, wherein the role comprises a plurality of roles associated with the entity, wherein the processing device is configured to determine the cognitive parameter corresponding to each role of the plurality of roles, wherein the communication device is further configured to transmit each of the cognitive parameter to at least one of the candidate device and the entity device, wherein the plurality of roles are arranged in a specified order based on a criterion associated with each of the cognitive parameter.

15. A computer program product comprising a computer-readable medium with computer-executable code encoded therein, the computer-executable code adapted to be executed to implement a method comprising: a recruitment system, wherein the recruitment system comprises: an assessment module configured to administer at least one cognitive assessment to a user and generate a unique cognitive profile based on the user's assessment results; a calculation module configured to: receive the unique cognitive profile from the assessment module; compare the unique cognitive profile to at least one exemplar role profile, wherein the exemplar role profile includes cognitive traits of one or more employees identified as exemplars of successful performance in a specific role within a company; and generate a metric quantifying the user's potential to succeed in the specific role based on the comparison; a recommendation module configured to provide recommendations to the user based on the generated metric, wherein the recommendations include suggested roles within the company for which the user has a high potential for success providing by the assessment module a plurality of computerized tasks designed to measure a subject's general mental abilities, wherein the computerized tasks are based on at least a portion of the ONET Ability Profiler; quantifying a subject's potential to succeed in a role based on a statistical model of success for the role, wherein the statistical model is generated using linear regression algorithms; and identifying if a subject is suitable for hiring by an entity based on their quantified potential to recruiter or hiring manager.

16. A computer program product comprising a computer-readable medium with computer-executable code encoded therein, the computer-executable code adapted to be executed to implement a method comprising: a talent identification system, wherein the talent identification system comprises: an assessment module configured to administer at least one cognitive assessment to a user and generate a unique cognitive profile based on the user's assessment results; a calculation module configured to: receive the unique cognitive profile from the assessment module; compare the unique cognitive profile to at least one exemplar role profile, wherein the exemplar role profile includes cognitive traits of one or more employees identified as exemplars of successful performance in a specific role within a company; and generate a metric quantifying the user's potential to succeed in the specific role based on the comparison; a recommendation module configured to provide recommendations to the user based on the generated metric, wherein the recommendations include suggested roles within the company for which the user has a high potential for success; providing by the assessment module a plurality of computerized tasks designed to measure a subject's general mental abilities, wherein the computerized tasks are based on at least a portion of the ONET Ability Profiler; quantifying a subject's potential to succeed in a role based on a statistical model of success for the role, wherein the statistical model is generated using linear regression algorithms; and identifying if a subject is suitable for hiring by an entity based on their quantified potential to recruiter or hiring manager; providing by the assessment module a plurality of computerized tasks designed to measure a subject's general mental abilities; quantifying a subject's career propensity based on their potential to succeed based on a statistical model of success for the role; identifying a subject's identified career propensity to the subject and a learning and development officer.

17. The system of aspect 15, wherein the cognitive assessments measure one or more elements of General Mental Ability (GMA).

18. The system of aspect 17, wherein the elements of GMA include one or more of the following: arithmetic reasoning, verbal aptitude, spatial aptitude, and perceptual speed, and non-verbal reasoning.

19. The system of aspect 15, wherein the generated metric is a numerical value between 0 and 100, representing the user's potential to succeed in the specific role.

20. The system of aspect 16, wherein the cognitive assessments measure one or more elements of General Mental Ability (GMA).

21. The system of aspect 20, wherein the elements of GMA include one or more of the following: arithmetic reasoning, verbal aptitude, spatial aptitude, and perceptual speed, and non-verbal reasoning.

22. The system of aspect 15, wherein the generated metric is a numerical value between 0 and 100, representing the user's potential to succeed in the specific role.

Although the invention has been explained in relation to its preferred embodiment, it is to be understood that many other possible modifications and variations can be made without departing from the spirit and scope of the invention as hereinafter claimed.

1. A method of facilitating assessment of a suitability of a candidate for a role, the method comprising:
receiving, using a communication device, a reference cognitive data from an entity device associated with an entity, wherein the reference cognitive data is associated with a desired candidate associated with the role corresponding to the entity;
receiving, using the communication device, a candidate cognitive data associated with the candidate from at least one of a candidate device and the entity device, wherein the candidate cognitive data corresponds to a cognitive skill of the candidate;
analyzing, using a processing device, the candidate cognitive data and the reference cognitive data;
determining, using the processing device, a cognitive parameter based on the analyzing; and
transmitting, using the communication device, at least one of the cognitive parameter and a selection data based on the cognitive parameter to the entity device.

2. The method of claim 1, wherein each of the candidate cognitive data and the reference cognitive data corresponds to a plurality of cognitive skills comprising an attention span, a perceptive skill, a memory skill, a logical reasoning skill, a problem solving skill, and a processing skill.

3. The method of claim 1 further comprising transmitting, using the communication device, a candidate assessment data to at one of the candidate device and the entity device, wherein each of the candidate device and the entity device comprises an end processing device, an end communication device and an end presentation device, wherein the end presentation device is configured to present the candidate assessment data to the candidate, wherein the candidate cognitive data is based on a response corresponding to the candidate cognitive assessment, wherein the response is generated by the candidate.

4. The method of claim 1 further comprising receiving, using the communication device, a cognitive sensor data from at least one of a candidate device and the entity device, wherein each of the candidate device and the entity device comprises a sensor configured to generate the cognitive sensor data associated with the cognitive skill of the candidate.

5. The method of claim 1, wherein the reference cognitive data comprises a standard cognitive data associated with a desired cognitive skills data associated with the role.

6. The method of claim 1 further comprising:
generating, using the processing device, a recommendation plan associated with development of the cognitive skills of the candidate, wherein the generating of the recommendation plan is based on the candidate cognitive data and the reference cognitive data; and
transmitting, using the communication device, the recommendation plan to at least one of the candidate device and the entity device.

7. The method of claim 1 further comprising:
transmitting, using the communication device, a self-assessment data to at least one of the candidate device and the entity device, wherein each of the candidate device and entity device comprises an end processing device, an end input device and an end presentation device, wherein the end presentation device is configured to present a self-assessment data to the candidate, wherein at least one of the candidate device and the entity device is configured to receive a response corresponding to the self-assessment data from the candidate;
receiving, using the communication device, the response;
generating, using the processing device, a recommended role data associated with the entity, wherein generation of the recommended role data is based on the response and the cognitive parameter; and
transmitting, using the communication device, the recommended role data to at least one of the candidate device and the entity device.

8. The method of claim 1, wherein the analysis of the reference cognitive data and the candidate cognitive data is based on a machine learning model configured to determine a pattern associated with the reference cognitive data and the candidate cognitive data.

9. The method of claim 1, wherein the reference cognitive data is based on a reference response data corresponding to a reference assessment data, wherein the reference response data is provided by a plurality of desired candidates associated with the role.

10. The method of claim 9, wherein the processing device is further configured to generate a scaled score corresponding to reference response data corresponding to each of the plurality of desired candidates, wherein a reference cognitive data is generated using the scaled score based on a criterion and a mean of the scaled score.

11. A system for facilitating assessment of a suitability of a candidate for a role, the system comprising:
a communication device configured to:
receive a reference cognitive data from an entity device associated with an entity, wherein the reference cognitive data is associated with a desired candidate associated with the role corresponding to the entity;
receive a candidate cognitive data associated with the candidate from at least one of a candidate device and the entity device, wherein the candidate cognitive data corresponds to a cognitive skill of the candidate;
transmit at least one of a cognitive parameter and a selection data based on the cognitive parameter to the entity device;
a processing device communicatively coupled with the communication device, wherein the processing device is configured to:
analyze the candidate cognitive data and the reference cognitive data; and
determine the cognitive parameter based on the analyzing.

12. The system of claim 11, wherein each of the candidate cognitive data and the reference cognitive data corresponds to a plurality of cognitive skills comprising an attention span, a perceptive skill, a memory skill, a logical reasoning skill, a problem solving skill, and a processing skill.

13. The system of claim 11, wherein the communication device is further configured to transmit a candidate assessment data to at one of the candidate device and the entity device, wherein each of the candidate device and the entity device comprises an end processing device, an end communication device and an end presentation device, wherein the end presentation device is configured to present the candidate assessment data to the candidate, wherein the candidate cognitive data is based on a response corresponding to the candidate cognitive assessment, wherein the response is generated by the candidate.

14. The system of claim 11, wherein the communication device is further configured to receive a cognitive sensor data from at least one of a candidate device and the entity device, wherein each of the candidate device and the entity device comprises a sensor configured to generate the cognitive sensor data associated with the cognitive skill of the candidate, and a end communication device configured to transmit the cognitive sensor data.

15. The system of claim 11, wherein the reference cognitive data comprises a standard cognitive data associated with a desired cognitive skills data associated with the role.

16. The system of claim 11, wherein the processing device is further configured to generate a recommendation plan associated with development of the cognitive skills of the candidate, wherein the generating of the recommendation plan is based on the candidate cognitive data and the reference cognitive data, wherein the communication device is further configured to transmit the recommendation plan to at least one of the candidate device and the entity device.

17. The system of claim 11, wherein the communication device is further configured to:
transmit a self-assessment data to at least one of the candidate device and the entity device, wherein each of the candidate device and entity device comprises an end processing device and an end presentation device, wherein the end presentation device is configured to present a self-assessment data to the candidate, wherein at least one of the candidate device and the entity device is configured to receive a response corresponding to the self-assessment data from the candidate;
receive the response, wherein the processing device is further configured to generate a recommended role data associated with the entity, wherein generation of the recommended role data is based on the response and the cognitive parameter; and
transmit the recommended role data to at least one of the candidate device and the entity device.

18. The system of claim 11, wherein the analysis of the reference cognitive data and the candidate cognitive data is based on a machine learning model configured to determine a pattern associated with the reference cognitive data and the candidate cognitive data.

19. The system of claim 11, wherein the reference cognitive data is based on a reference response data corresponding to a reference assessment data, wherein the reference response data is provided by a plurality of desired candidates associated with the role.

20. The system of claim 19, wherein the processing device is further configured to generate a scaled score corresponding to reference response data corresponding to each of a plurality of desired candidates, wherein a reference cognitive data is generated using the scaled score based on a criterion and a mean of the scaled score.
